(19) United States
(12) Patent Application Publication
(10) Pub. No.: US 2014/0152804 A1
(43) Pub. Date: Jun. 5, 2014

(54) SUB-PIXEL IMAGING FOR ENHANCED PIXEL RESOLUTION

(71) Applicant: Seagate Technology LLC, Cupertino, CA (US)

(72) Inventors: Joachim Walter Ahner, Livermore, CA (US); Travis William Grodt, Fremont, CA (US); Florin Zavaliche, San Ramon, CA (US); Maissarath Nassirou, Fremont, CA (US); David M. Tung, Sunnyvale, CA (US); Tchernio T. Boytchev, San Jose, CA (US); Stephen Keith McLaurin, Sunnyvale, CA (US); Henry Luis Lott, Fremont, CA (US)

(73) Assignee: Seagate Technology LLC, Cupertino, CA (US)

(21) Appl. No.: 14/029,725

(22) Filed: Sep. 17, 2013

Related U.S. Application Data
(60) Provisional application No. 61/733,859, filed on Dec. 5, 2012.

(51) Int. Cl. G06K 9/20

(52) U.S. Cl. CPC G06K 9/20
USPC 348/92

(57) ABSTRACT

Provided herein is an apparatus comprising a photon detecting array configured to take images of an article, and a mount configured to mount and translate the article in a direction by a sub-pixel distance. In some embodiments, the sub-pixel distance is based on a pixel size of the photon detecting array.

### RELATED APPLICATIONS

This application claims the benefit of U.S. Provisional Patent Application No. 61/733,859, filed Dec. 5, 2012, by Ahner et al.

### BACKGROUND

An article fabricated on a production line may be inspected for certain features, including defects that might degrade the performance of the article or a system comprising the article. For example, a hard disk for a hard disk drive may be fabricated on a production line and inspected for certain surface features, including surface and subsurface defects that might degrade the performance of the disk or the hard disk drive. In some instances, a camera may be used to capture images of features of an article for use in performing detection, identification, and shape analysis of the features. Conventionally, a camera may have a fixed pixel resolution (e.g. 5 mega pixels). As such, the camera may not have the optimal pixel resolution to image certain types of features (e.g., small defects or multiple defects in close proximity to each other).

### SUMMARY

Provided herein is an apparatus comprising a photon detecting array configured to take images of an article, and a mount configured to mount and translate the article in a direction by a sub-pixel distance. In some embodiments, the sub-pixel distance is based on a pixel size of the photon detecting array.

These and other features and aspects of the embodiments may be better understood with reference to the following drawings, description, and appended claims.

### DRAWINGS

FIG. 1 shows an apparatus configured to produce an image of an article with an increased pixel resolution in accordance with an embodiment.

FIG. 2 illustrates a schematic of photons scattering from a surface feature of an article, through an optical set up, and onto a photon detector array in accordance with an embodiment.

FIGS. 3A-3C illustrate an example of recording images of a feature of an article and producing a composite image with a pixel resolution that is n times greater than a pixel resolution of a photon detector array in accordance with an embodiment.

FIGS. 4A-4C illustrate an example of recording images of a feature of an article and producing a composite image with a pixel resolution that is n times greater than a pixel resolution of a photon detector array in accordance with an embodiment.

FIGS. 5A-5C illustrate an example of recording images of a feature of an article and producing a composite image with a pixel resolution that is n times greater than a pixel resolution of a photon detector array in accordance with an embodiment.

FIG. 6 shows images of a complex feature on the surface of an article.

FIGS. 7A-7B shows an exemplary flow diagram for producing an image with an increased pixel resolution in accordance with an embodiment.

FIGS. 8A-8B shows an exemplary flow diagram for producing a composite image with an increased pixel resolution in accordance with an embodiment.

### DESCRIPTION

Before various embodiments are described in greater detail, it should be understood by persons having ordinary skill in the art that the embodiments are not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood by persons having ordinary skill in the art that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art to which the embodiments pertain.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “translating,” “transmitting,” “storing,” “determining,” “sending,” “combining” “providing,” “accessing,” “retrieving”, “selecting” “associating,” “configuring,” “initiating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

An article fabricated on a production line may be inspected for certain features, including defects, such as particle and stain contamination, scratches and voids, that might degrade the performance of the article or a system comprising the article. For example, a hard disk for a hard disk drive may be fabricated on a production line and inspected for certain surface features, including surface and subsurface defects that might degrade the performance of the disk or the hard disk drive.

In some instances, defect detection and inspection may be performed by imaging the article with a camera, such as a scientific complementary metal-oxide semiconductor (“sCMOS”) camera. The sCMOS camera may include a photon detector array with a fixed pixel resolution, such as 5 megapixels. In some instances, a higher pixel resolution is needed to perform shape analysis of certain defects (e.g., small defects or multiple defects in close proximity to each other). However, the pixel resolution of a camera may be limited by the number of pixel sensors of the photon detector array. As such, adjusting a camera to a higher resolution may necessitate adding more pixel sensors to the photon detector array, which may be appreciated is not an easy change. In some instances, the camera may be replaced with a camera with a higher pixel resolution, which may be expensive. As such, provided herein are apparatuses and methods for increasing the pixel resolution of an image of an article without substantially altering one or more of: the camera, the photon detector array, a light source, the optical set up and/or other devices that may be used to detect or inspect features of an article.

In some embodiments described herein, an image with a greater pixel resolution than a pixel resolution of a photon detector array may be produced by moving the article a specific distance and subsequently imaging the article. For instance, a hard disk may be placed on a mount that iteratively translates the hard disk by a sub-pixel distance to a new location and subsequently images the article at each new location, while the photon detector array and camera remain in a fixed location. Then, a composite image with a greater pixel resolution is produced by combining each of the recorded images of the article at each location.

In some embodiments, the sub-pixel distance may be 1/n of a pixel size of the photon detector array. The n represents an enhancement value that a pixel resolution of an image is increased by in comparison to the pixel resolution of the photon detector array. For example, if a pixel resolution of an image is to be increased by a factor of 9, then the article may be translated by 1/9^{th} of a pixel size of the photon detector array. By translating and imaging the article by 1/9^{th} of a pixel size in the longitudinal and latitudinal directions, it results in n², 81, images of the article. Then, the n² (e.g., 81) images are combined, thereby resulting in a composite image of the article that has a pixel resolution that is n (e.g., 9) times greater than the pixel resolution of the photon detector array. As the example illustrates, the embodiments described herein provide a mechanism to increase the pixel resolution of an article without physically altering the camera, the photon detector array, the optical set up, and/or other devices that may be used for feature detection and identification of an article.

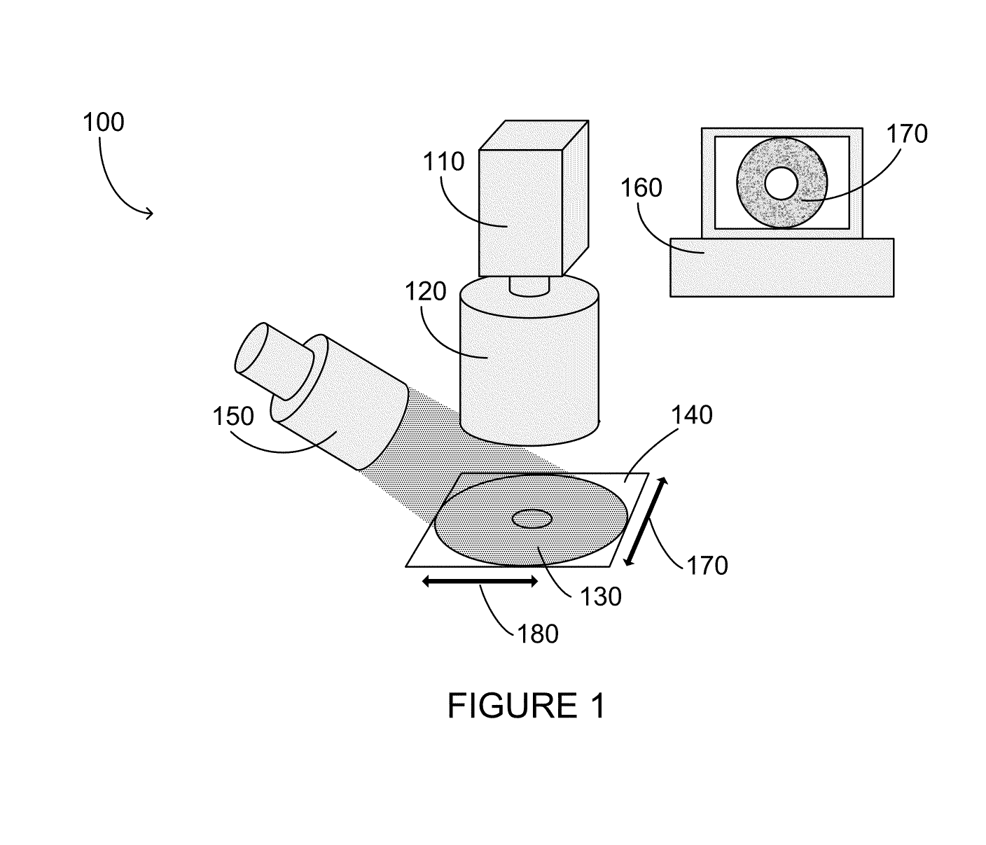

FIG. 1 shows an apparatus configured to produce an image of an article with an increased pixel resolution in accordance with an embodiment. The apparatus 100 comprises, but not limited to, a camera 110, an optical set up 120, an article 130, a mount 140, a photon emitter 150, a computer 160 displaying an image 170 of article 130 in accordance with an embodiment. It is appreciated that the articles and apparatuses described herein, as well as methods described herein, are exemplary and not intended to limit the scope of the embodiments.

In some embodiments, the apparatus 100 may be configured to produce a composite image of article 130 that has a greater pixel resolution than the pixel resolution of camera 110, without physically altering the camera 110, the optical set up 120, and/or the photon emitter 150. For instance, the mount 140 may be configured to translate the article 130 by a sub-pixel distance, which is described in greater detail below, to a new location. At each new location, the camera 110 and optical set up 120 capture photons scattered from features of the surface of article 130 as a result of emitting photons from photon emitter 150 onto the surface of article 130. Then, camera 110 may image article 130 and transmit the image to computer 160. After iteratively translating article 130 by a sub-pixel distance to each possible new location, computer 160 may combine the images captured by camera 110 and produce a composite image that has a pixel resolution greater than the pixel resolution of camera 110, which is described in greater detail below.

Before proceeding to further describe the various components of apparatus 100, it is appreciated that article 130 as described herein may be, but not limited to, semiconductor wafers, magnetic recording media (e.g., hard disks for hard disk drives), and workpieces thereof in any stage of manufacture.

Referring now to camera 110, in some embodiments, may be coupled to optical set up 120 and communicatively coupled to computer 160. In some embodiments, camera 110 may be configured to capture images of article 130 and transmit the captured images to computer 160 for processing and storage. In some embodiments, the camera 110 may be a complementary metal-oxide semiconductor (“CMOS”) camera, a scientific complementary metal-oxide semiconductor (“sCMOS”) camera, a charge-coupled device (“CCD”) camera, or a camera configured for use in feature detection and identification.

In some embodiments, camera 110 may be configured to be of a fixed pixel resolution, such as 1.3 megapixels, 5 megapixels, or 16 megapixels. It is appreciated that the fixed pixel resolution described are exemplary and are not intended to limit the scope of the embodiments. In some embodiments, camera 110 may have a pixel resolution that is at least 5 megapixels. In yet some embodiments, camera 110 may have pixel resolution that is less than 1 megapixel to more than 16 megapixels.

It is further appreciated that the pixel resolution of camera 110 may be fixed based on the characteristics of a photon detector array (not shown) used by camera 110. For instance, the pixel resolution may be based on the number of pixel sensors of the photon detector array. It may be further appreciated that the number of pixel sensors (e.g., a photon detector coupled to a circuit comprising a transistor for amplification) corresponds to the number of pixels of camera 110. As such, a higher pixel resolution camera may include a photon detector array with a greater number of pixel sensors compared to a lower pixel resolution camera.

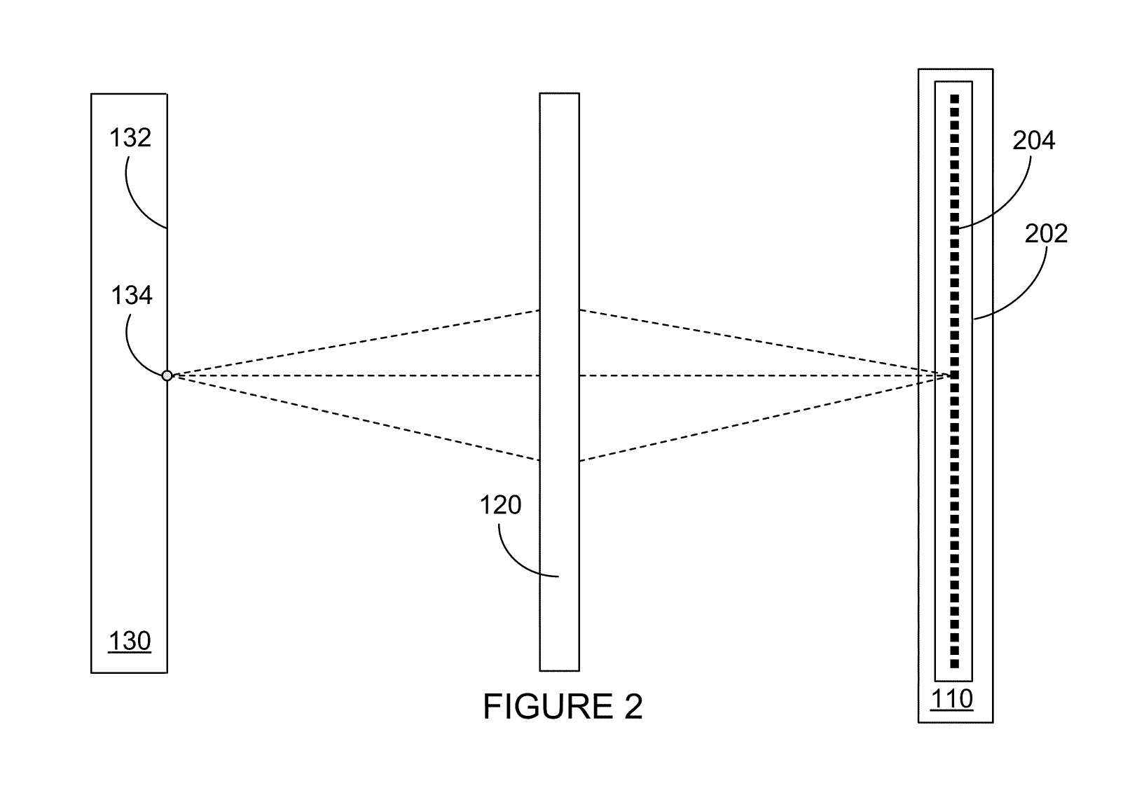

As noted above, in some embodiments, the camera 110 may include a photon detector array (e.g., photon detector array 202 of FIG. 2) configured to collect and detect photons scattered from features on the surface of article 130. The photon detector array of camera 110 may be used to capture images of features as article 130 is translated from one location to another location by a sub-pixel distance, which is described in greater detail below. Then, the captured images may be used to produce a composite image with a greater pixel resolution than the pixel resolution of the photon detector array.

In some embodiments, the photon detector array (e.g., photon detector array 202 of FIG. 2) may comprise a complementary metal-oxide semiconductor (“CMOS”), a scientific complementary metal-oxide semiconductor (“sCMOS”), or a charge-coupled device (“CCD”), which may be part of camera 110.

In some embodiments, the photon detector array (e.g., photon detector array 202 of FIG. 2) of camera 110 may comprise a plurality of pixel sensors (e.g., pixel sensors 204 of FIG. 2), which in turn, may each comprise a photon detector (e.g., a photodiode) coupled to a circuit comprising a transistor configured for amplification. In some embodiments, each of the pixel sensor may be arranged in a two dimensional array of a fixed pixel size. For example, the photon detector array of camera 110 may include 1 million (M) pixel sensors arranged in a two dimensional array, and the pixel size of each pixel sensor may be 6 micrometer (μm)×6 μm. In another example, the photon detector array of camera 110 may include 10 M photo sensors arranged in a two dimensional array, and the pixel size of each pixel sensor may be 3 μm×3 μm. It is appreciated that the number of photo sensors, pixel size, and the arrangement of the photo sensors are exemplary and are not intended to limit the scope of the embodiments. In some embodiments, the pixel sensors may be arranged in a rectangular shape or a circular shape. In some embodiments, the photon detector array of camera 110 may include 1 to more than 10 M pixels sensors of a pixel size that range from 1 μm to 10 μm. As such, the pixel sensors may be arranged and sized in a manner to detect and capture images of features of article 130 that may be significantly smaller (e.g., 100 times smaller) that the pixel size of the pixel sensor.

In some embodiments, the photon detector array and/or camera 110 may be oriented to collect and detect photons scattered from surface features of article 130 at an optimized distance and/or an optimized angle for a maximum acceptance of scattered light and/or one or more types of features. Such an optimized angle may be the angle between a ray (e.g., a photon or light ray) comprising the center line axis of the photon detector array to the surface of the article 130 and the normal (i.e., a line perpendicular to the surface of the article 130) at the point at which the ray is extended. The optimized angle may be equal to or otherwise include a scatter angle for one or more types of features, and the scatter angle may be a different angle than the angle of reflection, which angle of reflection is equal to the angle of incidence. For example, photon detector array and/or camera 110 may be oriented at an optimized angle ranging from 0° to 90°. Here, an optimized angle of 0° represents orientation of the photon detector array and/or camera 110 at a side of the article, an optimized angle of 90° represents orientation of the photon detector array or photon detector array directly above the article. Once an optimal distance and/or optimized angle is determined for the camera 110 and/or the photon detector array, the camera 110 and/or photon detector array do not need to be altered or repositioned to capture images of article 130 to produce an image with a greater pixel resolution than the pixel resolution of camera 110 and/or the photon detector array as described herein. By moving locations of article 130, it may be appreciated that the apparatus and methods described herein provide a mechanism to prevent a camera from moving out of alignment. Further, the mechanisms described herein increases productivity and efficiency in imaging by nearly eliminating the time needed to adjust and reposition a camera and/or a photon detector array to capture images of an article from a different angle and/or position.

Although FIG. 1 illustrates a single camera and is discussed with comprising a single photon detector array, it is intended to be exemplary and is not intended to limit the scope of the embodiments. In some embodiments, apparatus 100 may comprise a plurality of cameras comprising of a plurality of photon detector arrays. In some embodiments, apparatus 100 may comprise a plurality of cameras comprising a single photon detector array. In yet some embodiments, apparatus 100 may comprise a single camera comprising a plurality of photon detector arrays.

In some embodiments, optical set up 120 is coupled to camera 110. The optical setup 120, in some embodiments, may be configured to manipulate photons emitted from photon emitter 150, and/or photons scattered from the surface defects of article 130. The optical set up 150 may comprise any of number of optical components to manipulate photons/light scattered from features on a surface of the article. For example, the optical set up 120 may include, but are not limited to, lenses, mirrors, and filters (not shown). For instance, the optical set up 120 may comprise a lens (not shown) coupled to a photon detector array (not shown) of camera 110. The lens may be an objective lens, such as a telecentric lens, including an object-space telecentric lens (e.g., entrance pupil at infinity), an image-space telecentric lens (e.g., exit pupil at infinity), or a double telecentric lens (e.g., both pupils at infinity). Coupling a telecentric lens to a photon detector array reduces errors with respect to the mapped position of surface features of articles, reduces distortion of surface features of articles, and/or enables quantitative analysis of photons scattered from surface features of articles, which quantitative analysis includes integration of photon scattering intensity distribution for size determination of surface features of articles.

In some embodiments, the optical set up 120 may include filters (not shown), such filters may include, for example, wave filters and polarization filters. Wave filters may be used in conjunction with photon emitter 150 to provide light comprising a relatively wide range of wavelengths/frequencies, a relatively narrow range of wavelengths/frequencies, or a particular wavelength/frequency. Polarization filters may be used in conjunction with photon emitter 150 described herein to provide light of a desired polarization including polarized light, partially polarized light, or nonpolarized light.

It is appreciated that the orientation of optical set up 120 in FIG. 1 is exemplary and is not intended to limit the scope of the embodiments. In some embodiments, orientation of the optical set up 120 may be dependent on the orientation of camera 110. In some embodiments, the optical set up 120 may be oriented to collect and detect photons scattered from surface features of article 130 at an optimized distance and/or an optimized angle for a maximum acceptance of scattered light and/or one or more types of features. As noted above, such an optimized angle may be the angle between a ray (e.g., a photon or light ray) comprising the center line axis of the photon detector array to the surface of the article 130 and the normal (i.e., a line perpendicular to the surface of the article 130) at the point at which the ray is extended. The optimized angle may be equal to or otherwise include a scatter angle for one or more types of features, and the scatter angle may be a different angle than the angle of reflection, which angle of reflection is equal to the angle of incidence. For example, the optical set up 120 may be oriented at an optimized angle ranging from 0° to 90°. As noted above, an optimized angle of 0° represents orientation of the optical set up 120 at a side of the article 130, and an optimized angle of 90° represents orientation of the optical set up directly above the article. Once an optimal distance and/or optimized angle is determined, the optical set up 120 do not need to be altered or repositioned to capture images of article 130 to produce an image with a greater pixel resolution than the pixel resolution of camera 110 and/or the photon detector array as described herein. As noted above with respect to camera 110, by moving locations of article 130, mechanisms described herein prevent the optical set up 120 from moving out of alignment. Further, the mechanisms described herein increases productivity and efficiency in imaging by nearly eliminating the time needed to adjust, reposition, and/or maintain an orientation of an optical set up.

In some embodiments, apparatus 100 includes photon emitter 150 configured to emit photons on the entire or a portion of the surface of article 130. In some instances, the photon emitter 150 may emit light on the surface of article 130 to use to image the article for features. For example, the photon emitter 150 may emit white light, blue light, UV light, coherent light, incoherent light, polarized light, non-polarized light, or some combination thereof. As the photon emitter 150 emits photons and/or light on the surface of article 130, the photons or light may reflect and/or scatter from the surface of article 130 and may be captured by the optical setup 120 and camera 110, as described above. Although FIG. 1 illustrates a single photon emitter, it is intended to be exemplary and is not intended to limit the scope of the embodiments. For instance, apparatus 100 may comprise two or more, or any number of photon emitters.

It is further appreciated that the distance and angle of photon emitter 150 illustrated in FIG. 1 is exemplary and is not intended to limit the scope of the embodiments. Photon emitter 150 may emit photons or light onto the surface of article 130 at an optimized distance and/or optimized angle to detect and identify certain types of features. For instance, the angle of photon emitter 150 may be optimized based on an angle of incidence, which is the angle between a ray (e.g., a photon or light ray) comprising the emitted photons incident on the surface of the article and the normal (e.g., a line perpendicular to the surface of the article) at the point at which the ray is incident. For example, the photon emitter 150 may be optimized to emit photons at an angle of incidence ranging from 0° to 90°. Here, an angle of incidence of 0° represents the photon emitter 150 emitting photons onto the surface of the article 130 from a side of the article, and an angle of incidence of 90° represents the photon emitter 150 emitting photons onto the surface of the article 130 from directly above the article. Once an optimal distance and/or optimal angle for the photon emitter 150 is determined, it may be appreciated that photon emitter 150 does not need to be altered or repositioned in order to produce an image with greater pixel resolution than camera 110, as described herein. By moving the article 130, certain efficiencies are gained by nearly eliminating the time used in adjusting the photon emitter 150 in order to image an article for different types of features.

Apparatus 100 comprises a mount 140 on which article 130 may be laid upon in some embodiments. In some embodiments, the mount 140 may be a piezoelectric controlled stage, such as atomic force microscopy (“AFM”) stage. In some embodiments, the mount 140 may be positioned within apparatus 100 to allow the photon emitter 150 to emit photons or light on the surface of article 130, and allow the camera 110 and optical set up 120 to capture and image photons or light scattered from the surface of article 130.

In some embodiments, the mount 140 as part of a means for producing a composite image of the article, or a portion thereof, at a greater pixel resolution than the fixed pixel resolution of the photon detecting array by translating and imaging the article at sub-pixel distances. In some embodiments, the mount 140 may be configured to support and translate the article 130 by a sub-pixel distance in the latitude 170 and/or longitude 180 directions. For example, the mount 140 may translate, along with article 130, by 1/n of a pixel in the longitude direction 180. In another example, the mount 140 may translate, along with article 130, by 1/n of a pixel in the latitude direction 170. In yet another example, the mount 140 may translate along with article 130 by 1/n of a pixel in the latitude 170 and longitude 180 directions simultaneously. In these examples, after the mount 140 translates to each new location, camera 110 may image the article 130. As noted above, n represents an enhancement value that a pixel resolution of an image is increased by in comparison to the pixel resolution of the camera and/or photon detector array. Here, n may be any number, such as any number ranging between 2 to 10,000, inclusive.

In some embodiments, the mount 140 may be configured to translate the article 130 in response to receiving a signal from computer 160. In some embodiments, the mount 140 may be manually translated in the longitudinal 180 and/or latitudinal 170 directions. In some embodiments, the mount 140 may be configured to translate the article 130 in an up and down directions. For instance, the up and down directions may be a z-axis direction, whereas the latitudinal 170 and longitudinal 180 directions may refer to the y-axis and x-axis directions, respectively.

Further, apparatus 100 may include a computer 160. In some embodiments, the computer 160 may be communicatively coupled to camera 110 to record images of the article 130 captured by camera 110. In some embodiments, the computer 160 may be communicatively coupled to mount 140 to cause the mount 140 to iteratively translate article 130 by a sub-pixel distance. For example, the computer 160 may transmit a signal to mount 140 to translate article 130 by 1/n of a pixel in a longitudinal direction. After the article is translated, then computer may wait to record an image of the article, then transmit another signal to translate article 130 to a subsequent location. In some embodiments, the computer 160 may be configured to combine the recorded images, and produce and display a composite image 170 that has a greater resolution than a pixel resolution of camera 110.

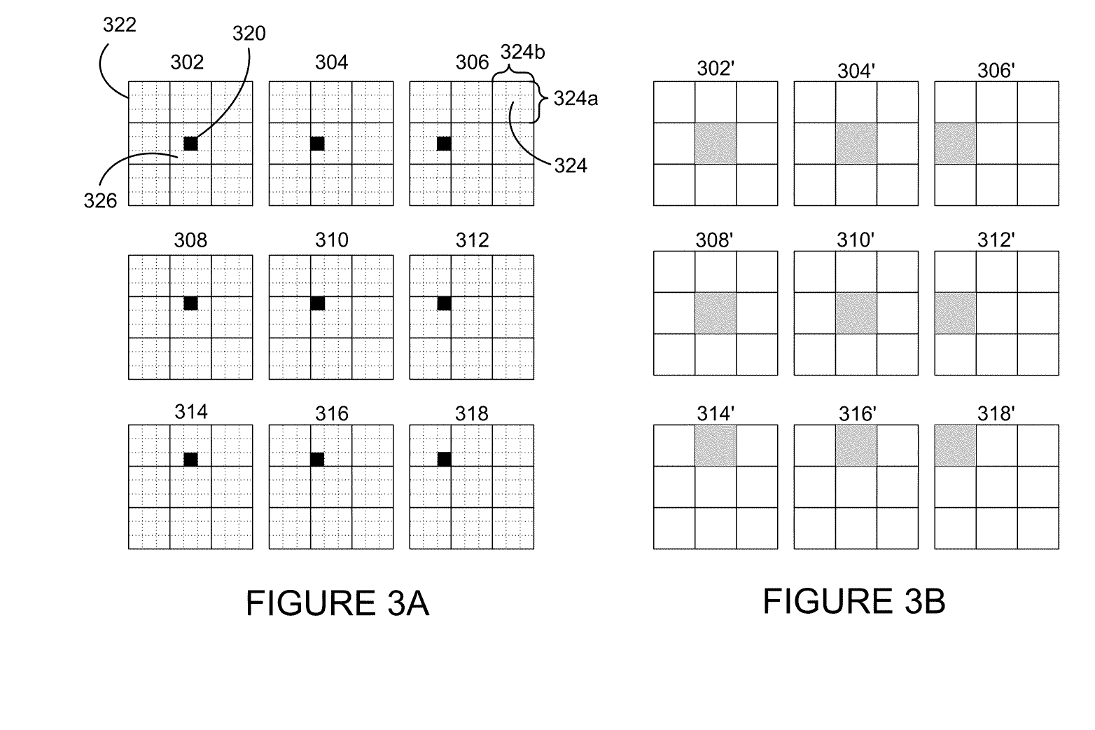

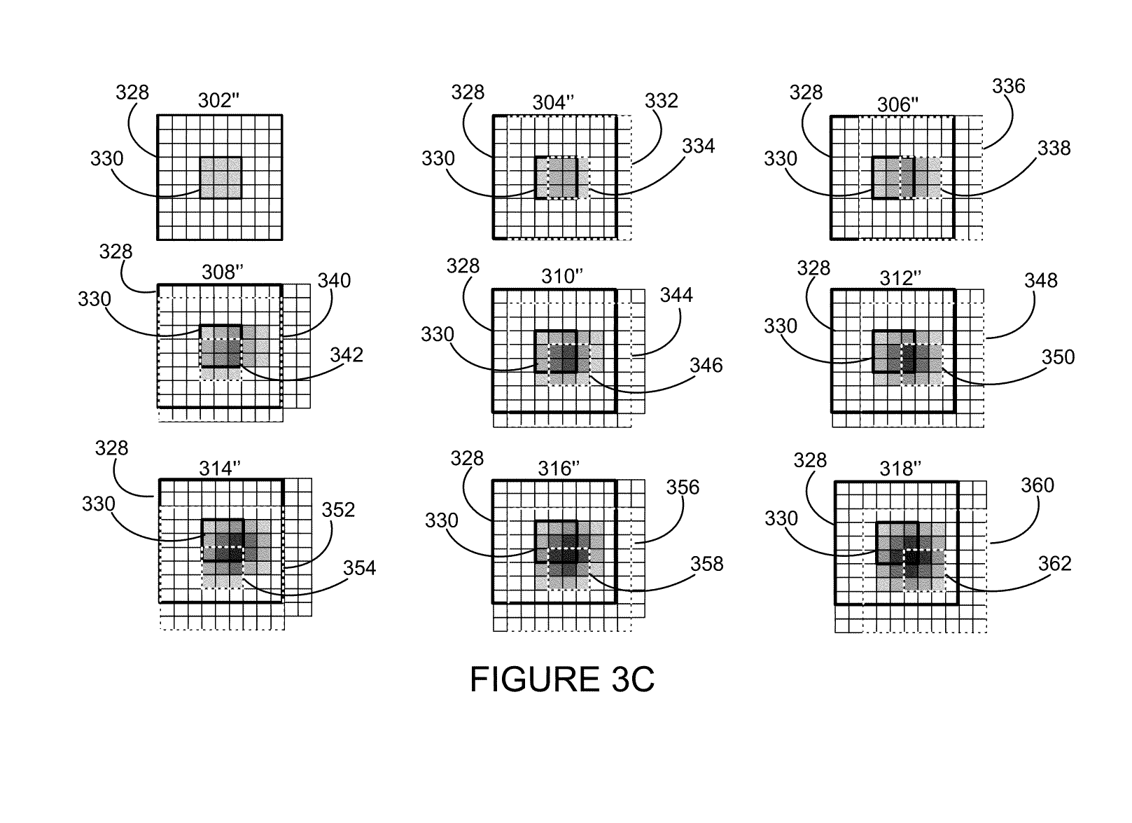

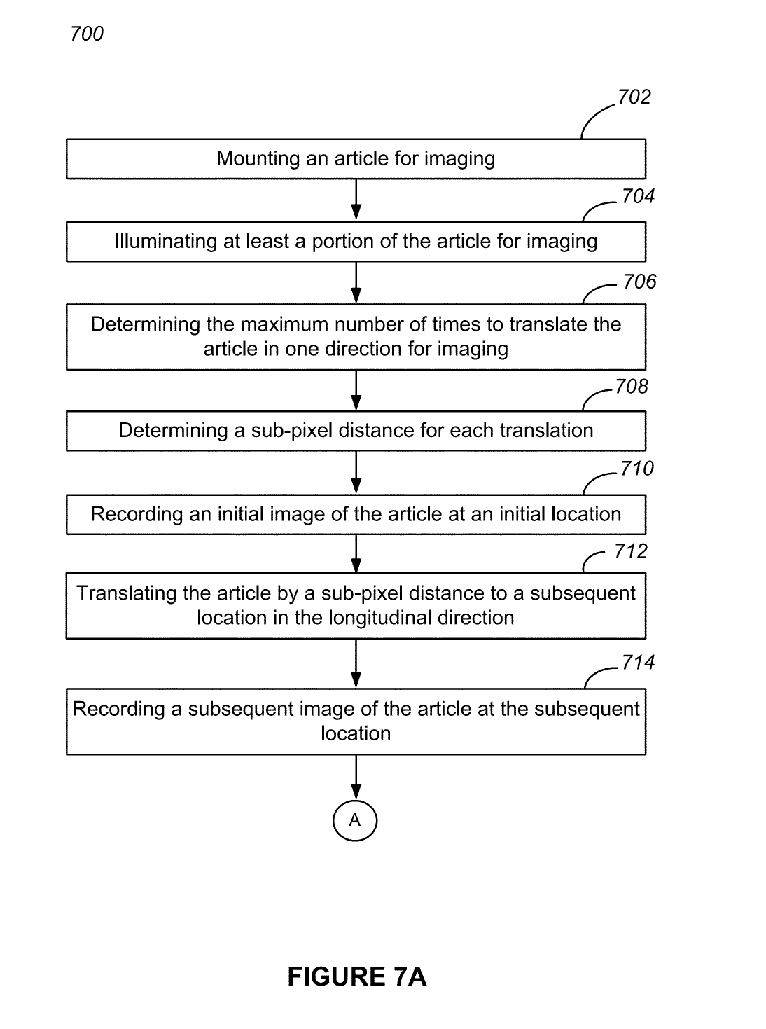

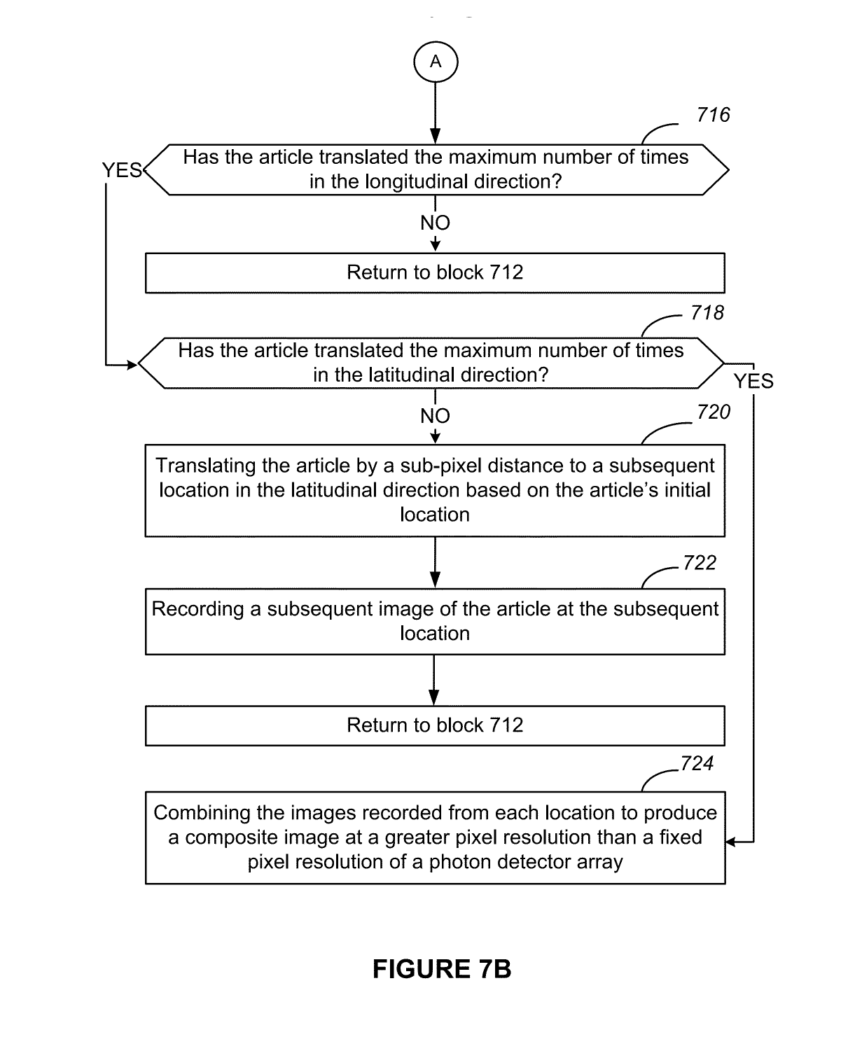

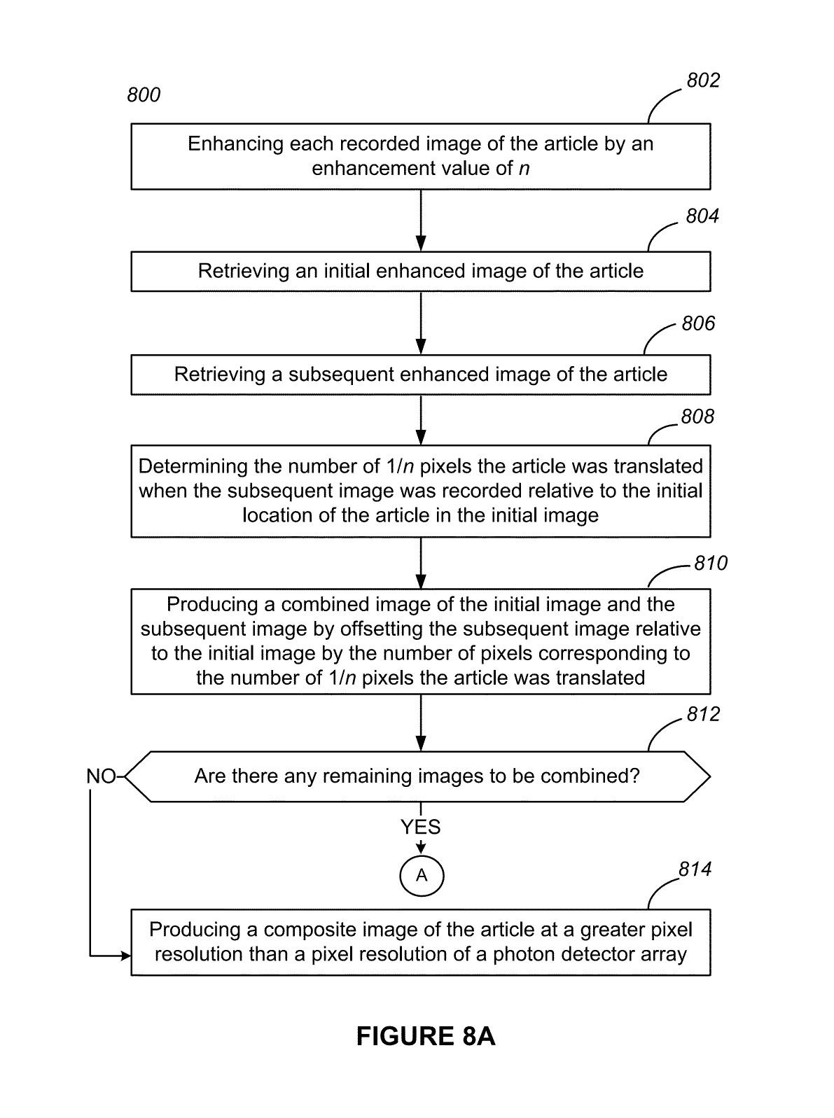

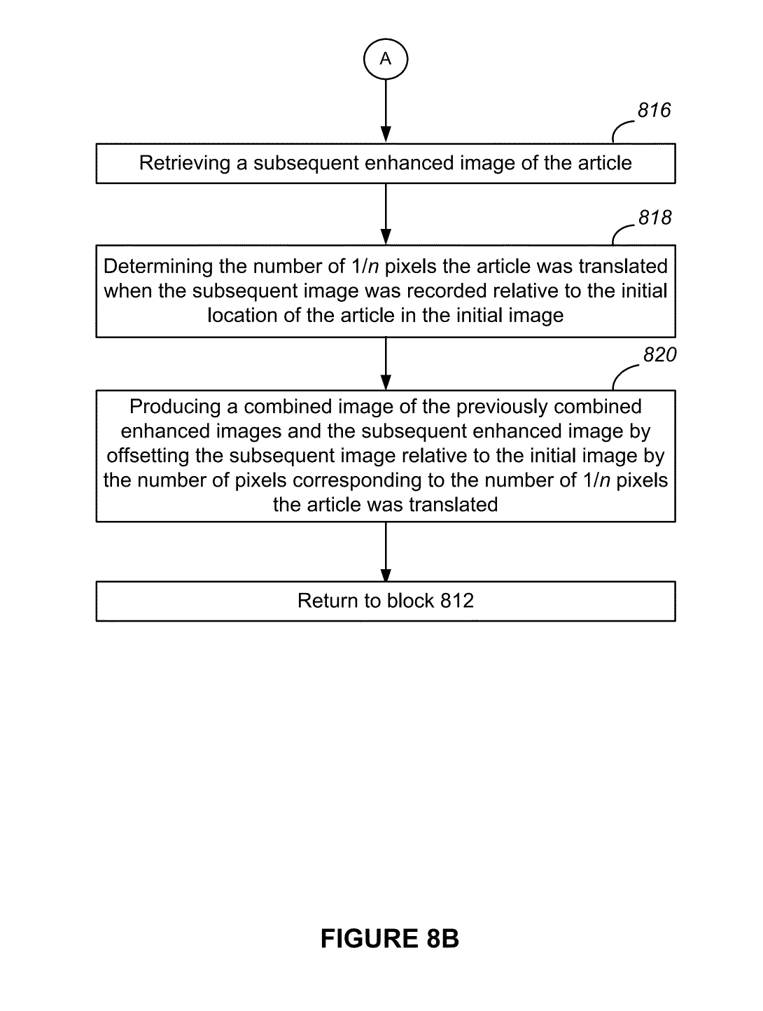

In some embodiments, the computer 160 may execute a computer program or a script to record images, iteratively cause the mount 140 and/or article 130 to translate, and combine the images to produce a composite image as described herein. In some embodiments, the computer 160 may be configured to perform a method as described in greater detail in FIGS. 7A-7B and FIGS. 8A-8B. It is appreciated that computer 160 may be a desktop computer, a workstation, a portable device (e.g., a mobile device, a tablet, a laptop, or a smartphone), or some computing device that may be configured to record images, translate a mount and/or an article and produce a composite image as described in FIGS. 3A-3C, FIGS. 4A-4C, FIGS. 5A-5C, FIGS. 7A-7B and FIGS. 8A-8B. In some embodiments, the computer 160 may be further configured to identify features of article 130, such as disk defects.

Referring now to FIG. 2, a schematic of photons scattering from a surface feature of an article, through an optical set up, and onto a photon detector array is illustrated in accordance with an embodiment. As illustrated in FIG. 2, article 130 comprises a surface 132 and a surface feature 134. Photons emitted from a photon emitter, such as photon emitter 150 of FIG. 1, or a plurality of photon emitters may be scattered by the surface feature 134 and collected and detected by the optical setup 120 in combination with photon detector array 202 of camera 110. The optical setup 120, which may comprise a telecentric lens, may collect and focus the photons scattered from the surface feature 134 onto one or more pixel sensors 204 of photon detector array 202, which each may comprise a photon detector coupled to an amplifier. The one or more pixel sensors 204, each of which corresponds to a pixel in a map of article's 130 surface, may provide one or more signals to a computer, such as computer 160 described in FIG. 1, to record an image of the article 130 corresponding to each pixel captured by camera 110. Then, the computer may be further configured to produce a composite image of the recorded images that has a greater pixel resolution than camera 110 and/or of the photon detector array 202 as described herein.

Although FIG. 2 illustrates an article with a single feature, it is intended to be exemplary and not intended to limit the scope of the embodiments. It is appreciated that an article may have more than one feature, which may be imaged for feature detection, identification and/or feature analysis.

FIGS. 3A-3C, FIGS. 4A-4C and FIGS. 5A-5C illustrate examples of recording images of a feature of an article and producing a composite image with a pixel resolution that is n times greater than a pixel resolution of a photon detector array in accordance with some embodiments. Before proceeding to describe each of the figures, some of the terms, features and components illustrated are described to provide some clarity. For instance, in FIGS. 3A-3C, FIGS. 4A-4C and FIGS. 5A-5C, the embodiments describe producing a composite image with a pixel resolution that is 3 times greater than the pixel resolution of the photon detector array used to capture images of an article. In other words, the enhancement value n is 3 as illustrated in FIGS. 3A-3C, FIGS. 4A-4C and FIGS. 5A-5C. However, it is appreciated that an enhancement value of 3 is exemplary and is not intended to limit the scope of the embodiments. It is appreciated that the enhancement value n may be between 2 and 10,000, inclusive, in some embodiments. In some embodiments, the enhancement value n may be at least 2, thereby resulting in a composite image with a pixel resolution that is at least two times greater than the fixed pixel resolution of the photon detecting array. In some embodiments, the enhancement value n is at least 100, thereby resulting in a composite image with a pixel resolution that is at least 100 times greater than the pixel resolution of the photon detector array.

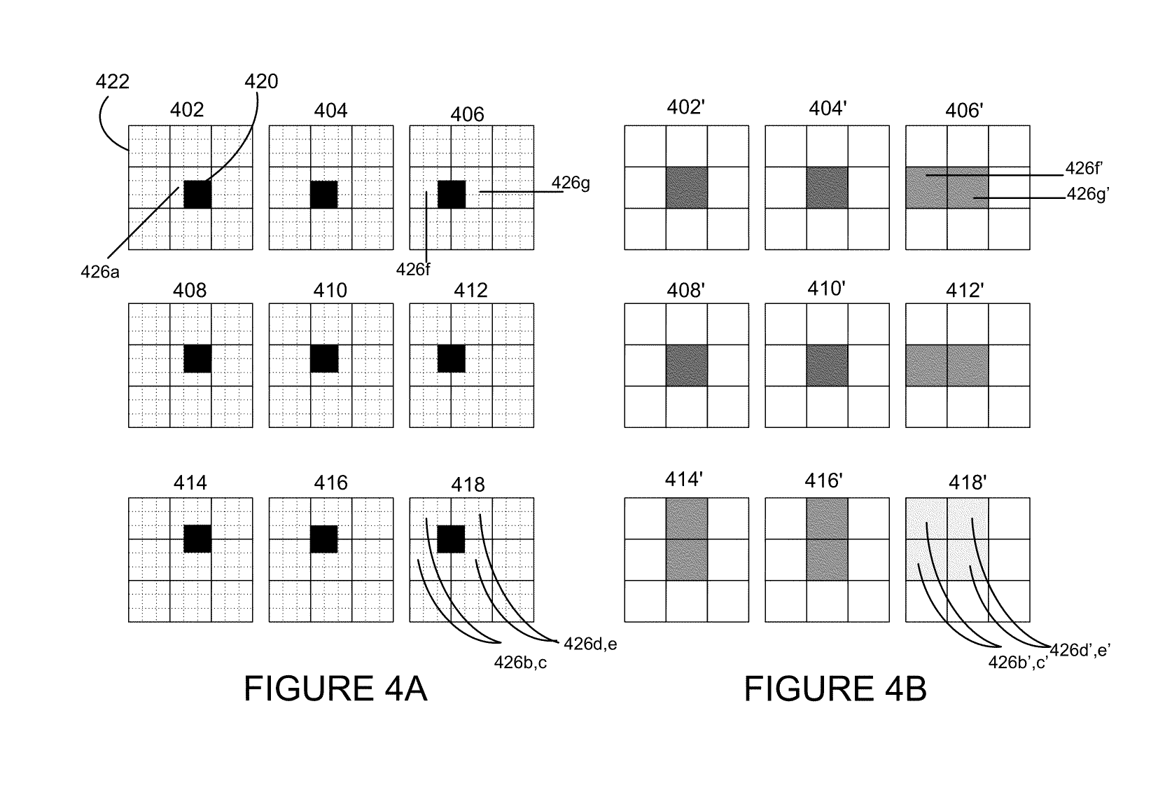

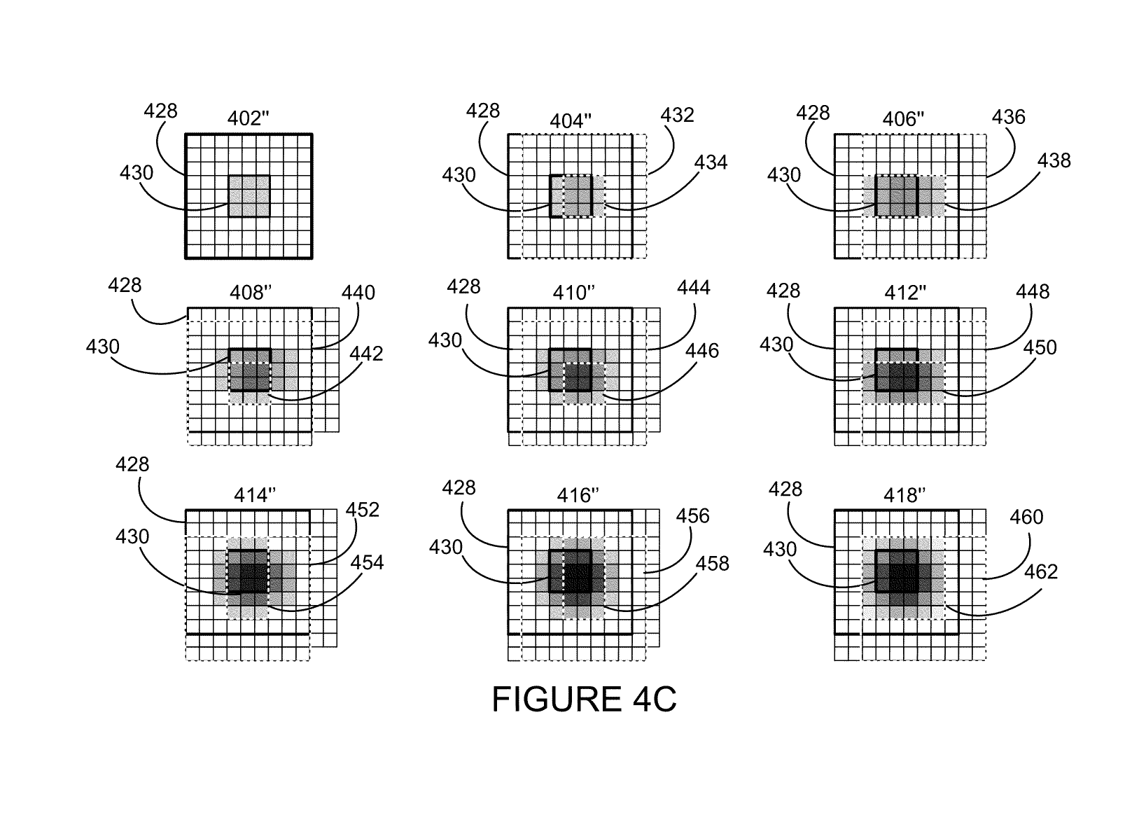

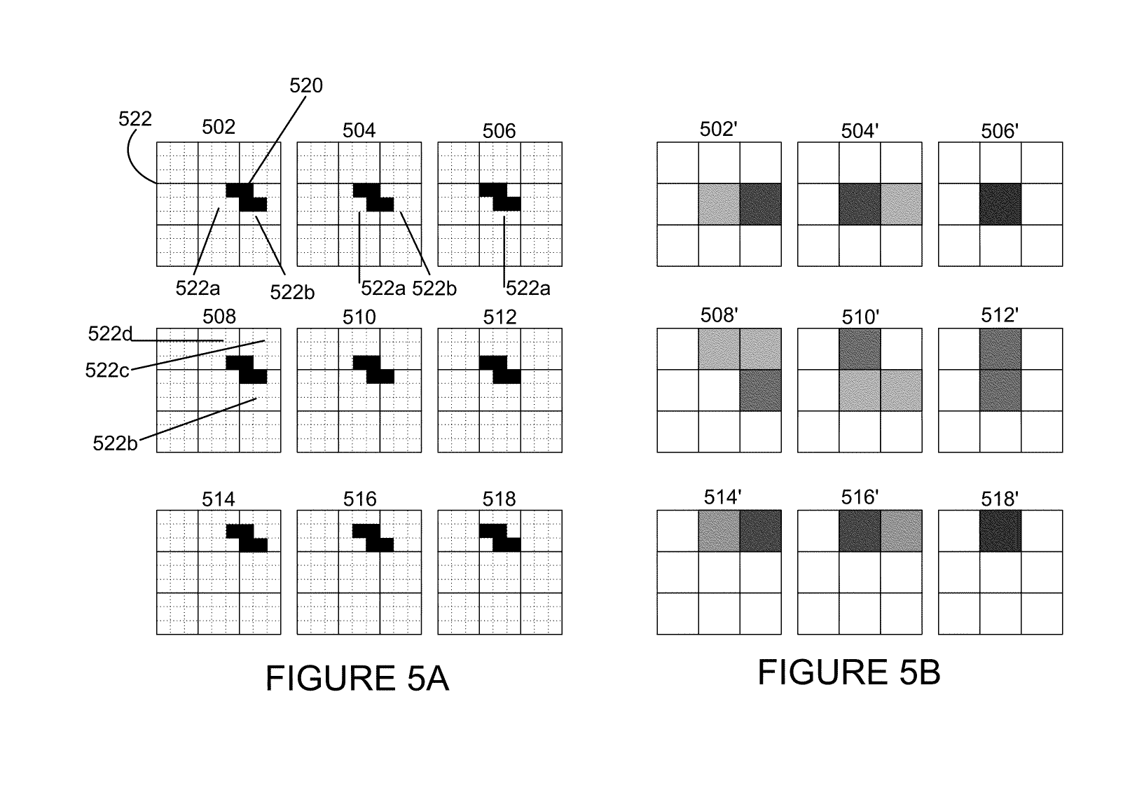

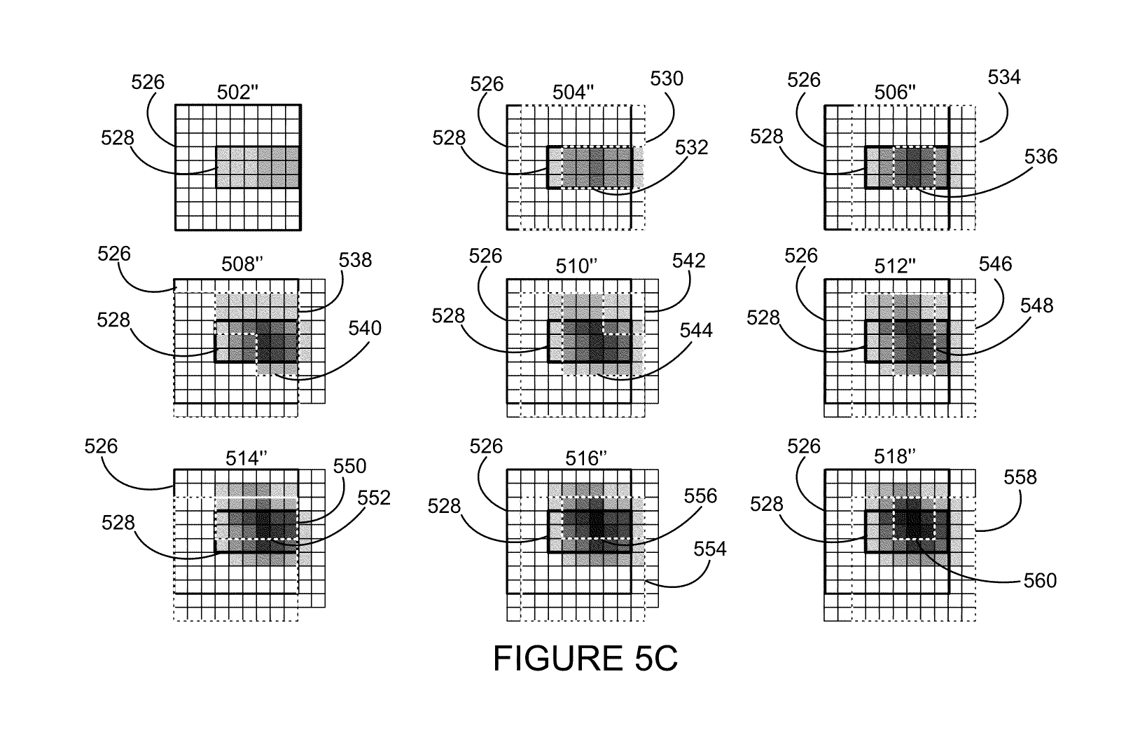

Further, FIGS. 3A-3C, FIGS. 4A-4C, and FIGS. 5A-5C, illustrate a photon detector array (e.g., photon detector arrays 322, 422 and 522 of FIGS. 3A, 4A, and 5A, respectively) comprising pixel sensors (e.g., 324 and 326 of FIG. 3A, 426a-g of FIG. 4A, and 522a-d of FIG. 5A) arranged in a 3×3 array. It is appreciated that each of the pixel sensors illustrated correspond to a pixel in a pixel image map, such as 3×3 pixel image maps 302′-318′ of FIG. 3B, pixel image maps 402′-418′ of FIG. 4B, and pixel image maps 502′-518′ of FIG. 5B.

It is noted that FIGS. 3A, 4A and 5A illustrate a perspective view from a non-moving photon detector array (e.g., photon detector array 322, 422 and 522 of FIGS. 3A, 4A and 5A, respectively) that detects a feature (e.g., feature 320, 420 and 520 of FIGS. 3A, 4A and 5A, respectively) of an article as the article is translated from one location to another location by a sub-pixel distance. Specifically, FIGS. 3A, 4A and 5A illustrate nine different locations (e.g., 302-318 of FIG. 3A, 402-418 of FIG. 4A and 502-518 of FIG. 5A) of a feature as viewed from the perspective of a non-moving photon detector array.

It is further noted that FIGS. 3A-3C, FIGS. 4A-4C and FIGS. 5A-5C illustrate producing a composite image with a pixel resolution that is 3 (e.g., enhancement value n) times greater than the pixel resolution of a photon detector array used to record images of the article. As illustrated in FIGS. 3A-3B, 4A-4B, and 5A-5B, the article is translated 9 times (n²) by a sub-pixel distance and subsequently imaged at each new location. As described herein a sub-pixel distance is based on pixel size (e.g., size of a pixel sensor), the magnification value of a lens (not shown), and the enhancement value n. For example, with reference to FIG. 3A, if the size of each pixel sensor (e.g., pixel sensor 324a & 324b) is 6 μm×6 μm, the magnification value of the lens is 0.2, and the enhancement value is 3 as noted above, then the sub-pixel distance is 0.4 μm (e.g., ⅓*(6 μm)*(0.2)).

For purposes of clarity, the FIGS. 3A, 4A and 5A illustrate an article being translated by a sub-pixel distance with the use of dashed lines that divide each pixel (e.g., pixel sensors) by ⅓ (e.g., 1/n), thereby dividing each pixel into a 3×3 array (e.g., n×n array). For ease of readability, the translation of an article by a sub-pixel distance is discussed in terms of 1/n of a pixel, rather in terms of μm distances. However, it is appreciated that the translation of 1/n of a pixel as described herein is provided an alternative manner to describe a sub-pixel distance.

Further, it is noted that FIGS. 3B, 4B and 5B illustrate grey scale pixel image maps (e.g., images 302′-318′ of FIG. 3B, images 402′-418′ of FIG. 4B and images 502′-518′ of FIG. 5B) of the feature of an article as detected by a photon detector array. Specifically, FIGS. 3B, 4B and 5B illustrate a 3×3 pixel map that corresponds to the 3×3 pixel sensors arrangement of the photon detector array. It is further appreciated that the intensity of the grey scale images reflects the density of a feature detected by one or more pixel sensors of a photon detector array. For example, in FIGS. 3A-3B, when feature 320 of an article is detected by photon detector array 322 at pixel 326 as illustrated in 302 of FIG. 3A, then a pixel image map 302′ of FIG. 3B provides a grey scale image of the location of the feature. In this example, the feature is a ⅓×⅓ of a pixel 326, which is 1/9 of a total area of the pixel 326. The pixel image map 302′ of FIG. 3B of feature 320 as illustrated in 302 of FIG. 3A is a grey scale image that represents 1/9 density of feature 320 as detected by pixel sensor 326 of the photon detector array 322. In another example, in FIGS. 4A-4B, the feature 420 of an article is about ⅔×⅔ area of a pixel 426a as illustrated in 402 of FIG. 4A, and pixel image map 402′ illustrated in FIG. 4B depicts a grey level intensity of feature 420 that represents a 4/9 of a pixel area as detected by pixel sensor 426a. In contrast, when the article along with feature 420 has changed to a different location as illustrated in 418 of FIG. 4A, then feature 420 is detected by four different pixel sensors (e.g., pixel sensors 426b-426e). As FIG. 4A illustrates that feature 420 covers about 1/9 of a pixel area of pixels 426b-426e. As such, pixel image map 418′ of FIG. 4B includes a grey level intensity in four different pixels (e.g., 426b′-426e′) that represents a 1/9 pixel area of feature 420 detected by the pixel sensors (426b-426e) of photon detector array 422. Although FIGS. 3B-3C, 4B-4C and 5B-5C illustrate grey scale images, it is intended to be exemplary and not intended to limit the scope of the embodiments. In some embodiments, the images disclosed herein may be RGB images.

Referring now to FIGS. 3A-3C, an example of recording images of a feature of an article and producing a composite image with a pixel resolution that is n (e.g., 3) times greater than a pixel resolution of a photon detector array in accordance with an embodiment. FIGS. 3A-3B illustrate n² (e.g., 9) images of a feature captured by a photon detector array of a camera as the article is translated to each new location by a sub-pixel distance (or by 1/n of a pixel). FIGS. 3A-3C further illustrate producing a composite image by combining 9 images of an article as the article was translated to a new location by of a sub-pixel distance (e.g., 1/n of a pixel).

In FIG. 3A, 302-318 illustrate locations of a feature 320 of an article with respect to a non-moving photon detector array 322 as the article is translated from one location to another location by ⅓ of pixel, and images 302′-318′ of FIG. 3B illustrate corresponding grey scale pixel image maps of feature 320 as it is projected into the pixel sensors (e.g., pixel sensors 324 and 326) of photon detector array 322.

In FIGS. 3A-3B, the article comprising feature 320 is iteratively translated to a new location by 1/n (e.g., ⅓ ) of a pixel to a new location, and subsequently an image of the article is recorded at each new location. FIGS. 3A-3B illustrate translating the article by 1/n of a pixel by forming a n×n matrix (e.g., a 3×3 matrix), thereby resulting in n² (e.g., 9) images to use to produce a composite image as described herein. For instance in FIG. 3A, location 302 illustrates the initial location of the article, and further illustrates feature 320 detected by pixel sensor 326 of photon detector array 322. When feature 320 is projected into the pixel sensor 326, the article and the feature 320 is recorded as a grey scale pixel image map 302′ of FIG. 3B. After image 302′ is recorded, then the article is translated by ⅓ of a pixel to the left as illustrated in 304 of FIG. 3A, and pixel image map 304′ of FIG. 3B is the image recorded of the article at new location 304. Then again, article is translated by ⅓ of a pixel to the left as illustrated in 306 of FIG. 3A, and a pixel image map 306′ of the article is recorded.

Similarly, 308-312 of FIG. 3A illustrate the article being translated in an upward latitudinal direction from the initial location of 302 by ⅓ of a pixel, and then translated by a ⅓ pixel in the left longitudinal directions. As noted above, pixel image maps 308′-312′ of FIG. 3B illustrate a grey scale image of the article as the article translates to each new location 308-312. In a similar manner, 314-318 of FIG. 3A illustrate the article translated in an upward latitudinal direction from initial location of 302 by a ⅔ of pixel, then translated by a ⅓ pixel in the left longitudinal directions. Then, pixel image maps 314′-318′ of FIG. 3B of the article is recorded at each new location. Although FIG. 3A illustrates iteratively translating an article by ⅓ of a pixel to form a 3×3 matrix, it is appreciated that translating the article in this manner is exemplary and not intended to limit the scope of the embodiments. For instance, in some embodiments, the article may be translated n² times in either only the latitudinal or longitudinal directions. Yet in some embodiments, the article may be iteratively translated by 1/n of pixel in a combination of latitudinal or longitudinal directions.

It is further appreciated in view of FIGS. 3A-3B that an article may be imaged by moving the article to different locations while the photon detector array 322 and other devices (e.g., optical set up and lens) remain in a fixed position.

After the article is imaged at each possible location, pixel image maps 302′-318′ are combined to form a composite image that has a pixel resolution that is 3 times greater than the pixel resolution of photon detector array 322 as illustrated in FIG. 3C.

FIG. 3C illustrates combining images 302′-318′ of FIG. 3B by (1) enhancing each recorded image (e.g., images 302′-318′) by a factor n (e.g., 3), and (2) combining the images by overlapping each image and offsetting the image by a pixel relative to the location of the initial image of an article as described in greater detail below.

Before proceeding to describe how a composite image is produced, some of the elements illustrated in FIG. 3C are discussed to provide clarity about how the images (e.g., images 302′-318′) are combined. For instance, the bolded perimeter 328 comprising a bolded perimeter 330 is used to identify the initial image of an article and the initial location of a feature within the image, respectively. The initial image (e.g., image 302″ of FIG. 3C) is used as a base to form a composite image as described herein. On the other hand, the dashed perimeter of an image (e.g., 332, 336, 340, 344, 348, 352, 356, and 360) of an article comprising a dashed perimeter (e.g., 334, 338, 342, 346, 350, 354, 358 and 362) of a feature within the image, respectively, are used to illustrate the placement of a subsequent image in relation to the initial image (e.g., image 302″), which is described in greater detail below. It is noted that similar bolded lines and dashed lines are used in FIGS. 4C and 5C.

Returning to FIG. 3B and FIG. 3C, the pixel image maps 302′-318′ are enhanced by a factor n, which is a factor of 3 in this example. For instance, image 302′ of FIG. 3B is changed from 3×3 pixel map to a 9×9 pixel map, such as image 302″ of FIG. 3C. Similarly, pixel image maps 304′-318′ are changed from 3×3 pixel maps to 9×9 pixel maps.

After images 302′-318′ of FIG. 3B are enhanced by a factor of n (e.g., 3), images 302″-318″ are combined. The images are combined by overlapping and offsetting each image by a pixel in one direction (e.g., longitude and/or latitude directions) relative to an initial image of the article.

In some embodiments, images 304″-318″ are combined with the initial image 302″ by offsetting the image in the inverse direction that the article was translated from the initial location (e.g., 302 of FIG. 3A) when a pixel image map (e.g., pixel image maps 304-318) was recorded. To provide an illustration, image 302″ is used as an initial image or as a base image to combine subsequent images. Then, image 304″ is combined with image 302″, which is highlighted with dashed perimeter 332 comprising the dashed perimeter 334 encapsulating a grey scale image of feature 320 (FIG. 3A). In this example, image 304″ is combined with image 302″ by offsetting image 304″ by 1 pixel in the right longitudinal direction relative to image 302″. Here, image 304″ offset is based on the number of 1/n (e.g., ⅓) pixels the article was translated and the directions the article was translated when image 304′ of FIG. 3B was recorded relative to the initial location of the article as illustrated in 302 of FIG. 3A. Specifically, it is noted that in FIG. 3A, the article along with feature 320 are translated by ⅓ of a pixel in left longitudinal direction compared to the initial location of the article as illustrated in 302 of FIG. 3A. As such, image 304″ is inversely offset by one pixel in the opposite direction (e.g., offset by one pixel in the right longitudinal direction). It is appreciated that by offsetting and then combining images, the pixel values of the images are added, thereby enhancing pixel resolution of the composite image. For instance, as illustrated in FIG. 3C, the intensity of the grey scale image of feature 320 is increased (e.g., pixel value) when images 302″ and 304″ are combined.

A similar process is repeated to combine each subsequent image. For example, image 306″ illustrated with a dashed line perimeter 336 comprising an image of feature 320 is illustrated by the dashed line perimeter 338 is combined with the previously combined images (e.g., images 302″ and 304″). In this example, image 306″ is offset by 2 pixels in the right longitudinal direction because the article was shifted by ⅔ of a pixel in the left longitudinal direction, as illustrated in 306 of FIG. 3A, from the initial location as illustrated in 302 of FIG. 3A. In another example, image 308″, which is illustrated by dashed perimeter 340 comprising a grey scale image of feature 320 surrounded by dashed perimeter 342, is combined with the previous images (e.g., images 302″-306″) by offsetting image 308″ by 1 pixel in the downward latitudinal direction relative to the initial image 302″ (e.g., depicted by bolded perimeter 328 comprising bolded perimeter 330 encapsulating grey scale image of feature 320). As noted above, because the article was translated by ⅓ pixel in the upward latitudinal direction, which is illustrated in 308 of FIG. 3A, relative to the initial location of the article as illustrated in location 302 of FIG. 3A, image 308″ is offset by 1 pixel in the opposite direction relative to the initial image 302″. In yet another example, image 310″, which is illustrated with dashed perimeter 344 comprising a grey scale image of feature 320 enclosed in dashed perimeter 346, is combined with the previously combined images (e.g., images 302″-308″) by offsetting the image 310″ by 1 pixel in the downward latitudinal direction and further by 1 pixel in the right longitudinal direction relative to the initial image 302″. In this example, it is appreciated that the image 310″ is offset in an inverse direction of the direction that the article was translated to location 310 of FIG. 3A relative to the initial location of article 302. In a similar manner, images 312″-318″ (which are illustrated by dashed perimeters 348, 352, 356 and 360 comprising a grey scale image of feature 320 enclosed in dashed perimeters 350, 354, 358 and 362, respectively) are each combined with the previously combined images by shifting the images in an inverse direction of the direction that the article was translated in comparison to the initial location of the article (e.g., 302 of FIG. 3A) when the article was imaged (e.g., images 312′-318′).

As FIG. 3C illustrate, by offsetting and combining the images 302″-318″, the region that includes image of feature 320 also overlap and the greyscale intensity values increase (e.g., becomes darker and darker). In this way, the pixel values of the images are added together, thereby resulting in an image with a pixel resolution that is n times (e.g., 3) greater than the pixel resolution of the camera and/or photon detector array used to record images of the article. In some embodiments, after images 302″-318″ are combined using an image interpolation process to produce a composite image with a greater pixel resolution than a camera and/or photon detector array.

Referring now to FIGS. 4A-4C, an example of recording images of a feature of an article and producing a composite image with a pixel resolution that is n (e.g., 3) times greater than a pixel resolution of a photon detector array is illustrated in accordance with an embodiment. In FIGS. 4A-4C an article is translated, imaged, and a composite image of the article is produced in a substantially similar manner as described in FIGS. 3A-3C, except that feature 420 of FIG. 4A is larger than feature 320 of FIG. 3A. As such, feature 420 may be detected and imaged by more than one pixel sensor of photon detector array 422.

Similar to 302-318 in FIG. 3A, 402-418 also illustrate a perspective view from a non-moving photon detector array 422 that detects feature 420 of an article as the article is iteratively translated from one location to another location by ⅓ of pixel. Similar to images 302′-318′ of FIG. 3B, pixel image maps 402′-418′ are grey scale images of the article as the article is translated to a new location.

As discussed previously, in order to produce a composite image with a pixel resolution that is n times greater than the pixel resolution of a photon detector array, then n² (9) images are recorded of the article as the article iteratively translates 1/n of a pixel to a new location. In FIGS. 4A-4B, nine images are recorded (e.g., images 402′-418′) as the article is translated by ⅓ of a pixel to produce a composite image that has a pixel resolution that is 3 times greater than the pixel resolution of photon detector array 422.

Similar to 302 of FIG. 3A and image 302′ of FIG. 3B, an initial pixel image map 402′ of FIG. 4B is recorded when the article is positioned at an initial location as illustrated in 402 of FIG. 4A. After the initial pixel image map 402′ is recorded, the article is translated by ⅓ of a pixel toward the left longitudinal direction as illustrated in 404 of FIG. 4A and subsequently imaged 404′ as illustrated in FIG. 4B. Similarly, the article is further translated by ⅓ of a pixel toward the left longitudinal direction as illustrated in 406 of FIG. 4A and imaged as image 406′ of FIG. 4B. In 406 of FIG. 4A, it is noted that feature 420 is detected by pixel sensors 426f and 426g. As such, the pixel image map 406′ illustrates a grey scale image of feature 402 in pixels 426f′ and 426g′ that correspond to pixel sensors 426f and 426g. In a similar manner, as the article is iteratively translated by ⅓ of pixel in the longitudinal and latitudinal directions as illustrated in 408-418 of FIG. 4A, corresponding pixel image maps 408′-418′ of the article are recorded.

Once n² (e.g., 9) images of the article recorded, then images 402′-418′ are combined to produce a composite image that has a pixel resolution that is greater than the pixel resolution of photon detector array 422.

Similar to FIG. 3C, images 402′-418′ of FIG. 4B are combined by (1) enhancing each captured image (e.g., images 302′-318′) by a factor n (e.g., 3), and (2) combining the images by overlapping each image and offsetting the image by a pixel relative to the location of the initial image (e.g., image 402′) of an article. Similar to FIG. 3C, the bolded perimeter 428 comprising bolded perimeter 430 is illustrated to identify the initial image (e.g., image 402″) used as a base to produce the composite image as described herein. In contrast, the dashed perimeter of an image (e.g., 432, 436, 440, 444, 448, 452, 456, and 460) of an article comprising a dashed perimeter (e.g., 434, 438, 442, 446, 450, 454, 458 and 462) of an image of feature 420 are used to illustrate the combination of a subsequent image relative to the initial image (e.g., image 402″).

To combine the pixel image maps 402′-418′ of FIG. 4B, the pixel image maps 402′-418′ are enhanced by a factor n, which is a factor of 3 in this example. For instance, image 402′ of FIG. 3B is changed from 3×3 pixel map to a 9×9 pixel map, such as image 402″ of FIG. 4C. Similarly, pixel image maps 404′-418′ are changed from 3×3 pixel maps to 9×9 pixel maps.

As described in FIG. 3C, after images 402′-418′ are enhanced by a factor of n (e.g., 3), the images 402″-418″ are combined by overlaying and offsetting each image by a pixel in a direction relative to the initial image of the article. As described in FIG. 3C, images (e.g., images 402″-418″) of FIG. 4C are offset in an inverse direction of the direction that the article was translated to a new location relative to an initial location of the article when the article was imaged. The amount an image is offset relative to an initial image is based on amount of 1/n of pixel the article was translated in latitudinal and/or longitudinal directions when an image of the article was recorded.

For example in FIG. 4C, image 402″ (depicted with bolded perimeter 428 comprising bolded perimeter 430 encapsulating a grey scale image of feature 420) is used as an initial image to combine subsequent images (e.g., images 404″-418″) to form a composite image with a greater pixel resolution. For instance, image 404″ (designated by dashed perimeter 432 comprising a grey scale image of feature 420 encapsulated by dashed perimeter 434) with image 402″ by offsetting image 404″ by 1 pixel in right longitudinal direction relative to the initial image 402″. As described in FIG. 3C, image 404″ is offset by 1 pixel based on the number of 1/n pixels the article was translated from the initial location of the article (402 of FIG. 4A). Referring to FIG. 4A, the article is translated by ⅓ of pixel in the left longitudinal direction in comparison to the location of article at 402. As such, image 404″ of FIG. 4C is offset by 1 pixel in the opposite direction that the article was translated by when the article was imaged (e.g., image 404′ of FIG. 4B).

In another example, image 406″ (which is designated by dashed perimeter 436 comprising a grey scale image of feature 420 enclosed by dashed perimeter 438) is combined with images 402″ and 404″ by offsetting image 406″ relative to image 402″ by a pixel amount based on the number of 1/n pixels the article was translated when image 406′ was recorded. In this example, the article is translated by ⅔ of a pixel in the left longitudinal direction as illustrated in 406 of FIG. 4A in comparison to the initial location of the article in 402. As such, image 406″ is shifted by 2 pixels in the right longitudinal direction and then combined with images 402″ and 404″. In this similar manner, images 408″-418″ (e.g., designated by dashed perimeters 440, 444, 448, 452, 456 and 460 comprising a grey scale image of feature 420 enclosed by dashed perimeters 442, 446, 450, 454, 456 and 462, respectively) are combined to produce a composite image that has 3 times greater pixel resolution than the pixel resolution of photon detector array 422 of FIG. 4A.

Referring now to FIGS. 5A-5C, an example of recording images of a feature of an article and producing a composite image with a pixel resolution that is n (e.g., 3) times greater than a pixel resolution of a photon detector array is illustrated in accordance with an embodiment. In FIGS. 5A-5C an article is translated, imaged, and a composite image of the article is produced in a substantially similar manner as described in FIGS. 3A-3C and FIGS. 4A-5C, except that feature 520 of FIG. 5A is an asymmetrical feature that may be detected and imaged by more than one pixel sensor of photon detector array 522.

FIG. 5A, similar to FIGS. 3A and 4A, illustrates a perspective view from a non-moving photon detector array 522 that detects feature 520 of an article as the article translated from one location to another location by increments of ⅓ of a pixel. As the article is iteratively translated to a new location by a ⅓ of a pixel as illustrated by in 502-518 of FIG. 5A, pixel image maps of the article (e.g., images 502′-518′ of FIG. 5B) are recorded.

As discussed previously, in order to produce a composite image with a pixel resolution that is n times greater than the pixel resolution of a photon detector array, then n² images are recorded of the article as the article iteratively translates by 1/n of a pixel. In FIGS. 5A-5B, nine images are recorded (e.g., images 502′-518′) to produce a composite image that has a pixel resolution that is 3 times greater than the pixel resolution of photon detector array 522.

As described in FIGS. 3A-3B and FIGS. 4A-4B, an initial pixel image map 502′ of FIG. 5B is recorded of the article at an initial location as illustrated in 502 of FIG. 5A. After the initial pixel image map 502′ is recorded, the article is translated by ⅓ of a pixel toward the left longitudinal direction as illustrated in 504 of FIG. 5A and subsequently a pixel image map (e.g., image 504′ of FIG. 5B) of the article is record. Similarly, the article is further translated by ⅓ of a pixel toward the left longitudinal direction as illustrated in 506 of FIG. 5A and imaged as pixel image map 506′ of FIG. 5B. It is noted that image 506′ illustrates a grey scale image of feature 520 as detected by a single pixel sensor (e.g., pixel sensor 522a of photon detector array 522 of FIG. 5A). In contrast, images 502′ and 504′ reflect that feature 520 were detected by two different pixel sensors (e.g., pixel sensor 522a and 522b as illustrated in FIG. 5A). In yet another example, when the article is translated by ⅓ pixel in an upward latitudinal direction as illustrated in 508 of FIG. 5A relative to the initial location of the article as illustrated in 502 of FIG. 5A, a pixel image map 508′ is recorded. In this example, pixel image map 508′ of the article reflects that feature 520 was detected by three different pixel sensors (e.g., pixel sensors 522b, 522c and 522d) of the photon detector array 522. In a similar manner, as the article is iteratively translated by ⅓ of pixel in the longitudinal and latitudinal directions as illustrated in 510-518 of FIG. 5A, corresponding pixel image maps 510′-518′ of the article are generated at each new location.

Once n² (e.g., 9) images of the article are imaged at each location, then images 502′-518′ are combined to produce a composite image that has a pixel resolution that is greater than the pixel resolution of photon detector array 522.

Similar to FIGS. 3C and 4C, images 502′-518′ of FIG. 5B are combined by (1) enhancing each recorded image (e.g., images 502′-518′) by a factor n (e.g., 3), and (2) combining the images by overlapping each image and offsetting the image by a pixel relative to the initial image of an article. Similar to FIGS. 3C and 4C, the bolded perimeter 526 comprising bolded perimeter 528 is illustrated to identify the initial image (e.g., image 502″) used as a base to produce the composite image as described herein. In contrast, the dashed perimeter of an image (e.g., 530, 534, 538, 542, 546, 550, 554, and 558) of an article comprising a dashed perimeter (e.g., 532, 536, 540, 544, 548, 552, 556, and 560) of an image of feature 520 are used to illustrate the combination of subsequent images relative to the initial image (e.g., image 502″).

To combine the pixel image maps 502′-518′ of FIG. 5B, the pixel image maps 502′-518′ are enhanced by a factor n, which is a factor of 3 in this example. For instance, image 502′ of FIG. 5B is changed from 3×3 pixel map to a 9×9 pixel map, as illustrated by image 502″ of FIG. 4C. Similarly, pixel image maps 504′-518′ are changed from 3×3 pixel maps to 9×9 pixel maps.

As described in FIGS. 3C and 4C, after images 502′-518′ are enhanced by a factor of n (e.g., 3), the images 502″-518″ are combined by overlaying and offsetting each image by a pixel in a direction relative to the initial image of the article. As described in FIGS. 3C and 4C, images (e.g., images 502″-518″) of FIG. 5C are offset in an inverse direction of the direction that the article was translated to relative to an initial location of the article when the article was imaged. The amount an image is offset relative to an initial image is based on amount of 1/n of a pixel the article was translated and the direction the article was translated.

In FIG. 5C, image 502″ is used as an initial image to combine subsequent images (e.g., images 504″-518″) to form a composite image with a greater pixel resolution. For instance, image 504″ (designated by dashed perimeter 530 comprising a grey scale image of feature 520 encapsulated by dashed perimeter 532) with image 502″ by offsetting image 504″ by 1 pixel in the right longitudinal direction relative to the initial image 502″. As described in FIGS. 3C and 4C, image 504″ is shifted by 1 pixel based on the number of 1/n pixels the article was translated relative to the initial location of the article (502 of FIG. 5A). Referring to FIG. 5A, the article is translated by ⅓ of pixel in the left longitudinal direction as illustrated in 504 of FIG. 5A in comparison to the location of article at 502. As such, image 504″ of FIG. 5C is shifted by 1 pixel in the opposite direction that article was translated when the article was imaged (e.g., image 504′).

In another example, image 506″ (which is designated by dashed perimeter 534 comprising a grey scale image of feature 520 enclosed by dashed perimeter 536) is combined with images 502″ and 504″. Image 506″ is combined by offsetting image 506″ relative to image 502″ by a pixel amount corresponding to the number of 1/n pixels the article was moved when image 506′ was recorded. In this example, the article is translated by ⅔ of a pixel in the left longitudinal direction as illustrated in 506 of FIG. 5A in comparison to the initial location of the article in 502. As such, image 506″ is shifted by 2 pixels in the right longitudinal direction and then combined with images 502″ and 504″. In this similar manner, images 508″-518″ are combined with the previously combined images to produce a composite image that has a pixel resolution that is 3 times greater than the pixel resolution of photon detector array 522 of FIG. 5A. It is noted that images 508″, 510″ and 512″ are designated by dashed perimeters 538, 542, 546 comprising dashed perimeters 540, 544 and 548 encapsulating grey scale images of feature 520, respectively. It is further noted that images 514″, 516″ and 518″ are designated by dashed perimeters 550, 554 and 558 comprising dashed perimeters 552, 556 and 560 encapsulating grey scale images of feature 520, respectively.

As FIG. 5C illustrates, by combining multiple images of features of an article, the pixel values are added together and the pixel values increase. For example in FIG. 5C, as the images (e.g., images 502″-518″) are combined the grey scale intensities values increase (e.g., becomes darker and darker). As a result, the final image has a pixel resolution that is greater than the pixel resolution of the camera and/or the photon detector array used to capture the images of the article.

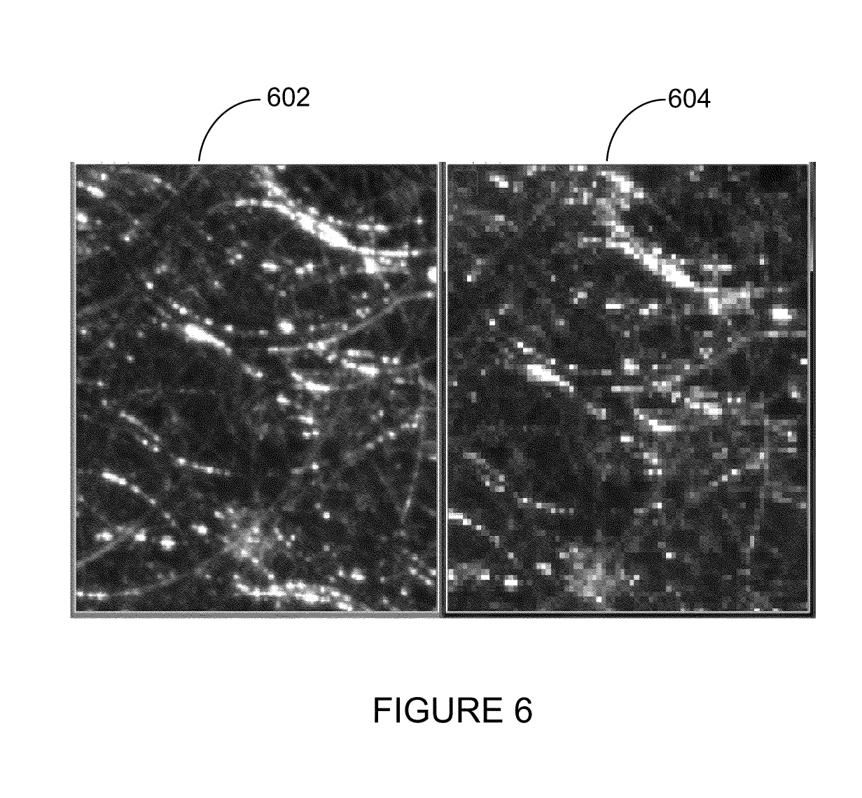

Referring now to FIG. 6, images of a complex feature on the surface of an article is shown. In FIG. 6, images 602 and 604 are captured by an apparatus with a set-up similar to one described in FIG. 1. Specifically, images 602 and 604 are captured by an apparatus comprising a CMOS camera and a telecentric lens with a magnification value of 0.2. Image 602 is a composite image of multiple images of a complex feature on the surface of an article that is generated utilizing the techniques described in FIGS. 3A-3C, FIGS. 4A-4C and FIGS. 5A-5C and the methods described in FIGS. 7A-7B and FIGS. 8A-8B. Image 602 is a composite image of nine images, thereby resulting in image 602 with a pixel resolution that is 3 times greater pixel resolution than the pixel resolution of the CMOS camera utilized to capture images of the article. In contrast, image 604 is a single image of the same complex feature on the article. Although images 602 and 604 utilize the same camera and optical set up to record images of the complex feature, image 602 allows many subtle details about the complex feature of the article to be visible that are not visible in image 604. It is also appreciated that by utilizing the techniques described herein a composite image (e.g., image 602) with a greater pixel resolution may be produced without adjusting the camera, optical set up and other devices to record images of features of an article. In this way, more information about features of an article may be gathered without substantially changing the devices used to record images of an article.

Referring now to FIGS. 7A-7B, an exemplary flow diagram is shown for producing an image with an increased pixel resolution in accordance with an embodiment. In some embodiments, parts or the entire method of 700 may be performed by a computing device, such as computer 160 of FIG. 1. At block 702, an article for imaging is mounted. In some embodiments, the article may be a disk, a semiconductor wafer, a magnetic recording media (e.g., hard disks for hard disk drives), and/or a workpiece in any stage of manufacture that may be laid upon a mount. In some embodiments, the article may be mounted on a mount of an apparatus substantially similar to mount 140 of apparatus 100 of FIG. 1.

At block 704, a portion of the article may be illuminated for imaging. In some embodiments, the entire article may be illuminated or a region of interest of the article may be illuminated. For example, a region of interest may an area of the article that includes a defect or a feature. In some embodiments, the article may be illuminated by a photon emitter, such as photon emitter 150 of FIG. 1, in a substantially similar manner as described in FIG. 1.

At block 706, the maximum number of times to translate the article in the one direction (e.g., longitudinal and latitudinal directions) is determined. In some embodiments, the maximum number of times an article is translated in one direction is based on the enhancement factor n. In some embodiments, in order to produce n² images on article, the article is translated from one location to another location in the form of an n×n matrix and imaged at each subsequent location, as illustrated in FIGS. 3A-3B, FIGS. 4A-4B, and 5A-5B. For example, if the enhancement value is 2, then the maximum number of times an article translates in the longitudinal and latitudinal directions is 2. In another example, if the enhancement value is 10, then the maximum number of times an article translates in the longitudinal and latitudinal directions is 10. For example with reference to FIG. 3A, the maximum number of times an article was translated in the longitudinal direction is 3. More specifically, in order to record nine images of the article, the article was translated three times in the longitudinal and latitudinal directions to move the article in the form of a 3×3 matrix. At block 708, a sub-pixel distance is determined for each translation of an article. In some embodiments, the sub-pixel distance may be based in part on the size of a pixel sensor of a photon detector array used to capture images of the article, a magnification value of a lens, and the enhancement value n. For example, as described with references to FIGS. 3A-3C, if the pixel size of pixel sensors 324a and 324b are 6 μm×6 μm, the magnification value is 0.2, and the enhancement factor is 3, then the sub-pixel distance for each translation is ⅓*(6 μm)*0.2=0.4 μm. In another example, if a pixel size of the pixel sensors is 3 μm×3 μm, and the magnification value is 0.5, and the enhancement factor is 100, then the sub-pixel distance for each translation is 0.15 μm of a pixel (e.g., 1/100*3 μm*0.5). In this way, the article is translated from one location to another location by a distance of 0.015 μm.

At block 710, an initial image of the article is recorded at an initial location. In some embodiments, the article may be imaged at an arbitrary location. In some embodiments, the article may be imaged an initial location as described with respect to the location of article in 302, 402 and 502 and images 302′, 402′, and 502′ in FIGS. 3A-3B, 4A-4B and 5A-5B, respectively.

At block 712, the article is translated a sub-pixel distance in a longitudinal direction to a subsequent location from the initial location of block 710. In some embodiments, the article may be translated by a sub-pixel distance in a longitudinal direction in a substantially similar manner as described in FIGS. 3A-3B, 4A-4B and 5A-5B.

At block 714, a subsequent image of the article is recorded at the subsequent location. In some embodiments, the image of the article may be captured by a camera, such as camera 110 of FIG. 1, and then recorded and stored by computer 160 of FIG. 1. In some embodiments, the recorded images may be substantially similar to pixel image maps 302′-318′ of FIG. 3B, pixel image maps 402′-418′ of FIG. 4B, and pixel image maps 502′-518′ of FIG. 5B.

At block 716 (FIG. 7B), it is determined whether the article has translated the maximum number of times in the longitudinal direction based on the maximum number of times determined in block 706. In some embodiments, the maximum number of times may be the enhancement value n. If it is determined that the article has not translated the maximum number of times in the longitudinal direction, then method 700 returns to block 712 to translate the article to a subsequent location in the longitudinal direction. Otherwise, method 700 proceeds to block 718.

At block 718, it is determined whether the article has translated the maximum number of times in the latitudinal direction based on the maximum number of times determined in block 706. If it is determined that the article has translated the maximum number of times in the latitudinal direction, then method 700 proceeds to block 724. Otherwise, method 700 proceeds to block 720.

At block 720, the article is translated a by a sub-pixel distance to a subsequent location in the latitudinal direction based on the article's initial location in block 710. In an illustrative example with reference to the embodiment described in FIG. 3A, the article comprising feature 320 is translated 3 times by a sub-pixel distance in left longitudinal direction as illustrated in 302-306 from the initial location of the article as illustrated in 302, then the article is translated by a sub-pixel distance (e.g., ⅓ of a pixel*magnification value of lens) in the upward latitudinal direction as illustrated in 308 of FIG. 3A. It is noted that the article is translated in the upward latitudinal direction in 308 relative to the initial location of the article as illustrated in 302. In some embodiments, the article may be translated in the latitudinal direction in a substantially similar manner as described and illustrated in FIGS. 4A and 5A.

At block 722, a subsequent image of the article at the subsequent location of block 720 is recorded. In some embodiments, the image may be recorded in a substantially similar manner as described in block 714. After the image is recorded, then method 700 returns to block 712.

Once the article has been translated the maximum number times in the longitudinal and latitudinal directions and n² images of the article have been recorded, then method 700 proceeds to block 724. At block 724, the recorded images of the article are combined to produce a composite image at a greater pixel resolution than a fixed pixel resolution of a photon detector array. In some embodiments, the images may be combined in a substantially similar manner as described in FIGS. 3C, 4C and 5C. In some embodiments, a composite image may be produced using the method described in FIGS. 8A-8B. In some embodiments, a means for producing a composite image, such as computer 160 of FIG. 1, may be used to produce the composite image.

FIGS. 8A-8B shows an exemplary flow diagram for producing a composite image with an increased pixel resolution in accordance with an embodiment. In some embodiments, all or parts of method 800 may be performed by a computing device, such as computer 160 of FIG. 1.

At block 802, each recorded image is enhanced by an enhancement value n. As described herein, the enhancement value n is a factor by which to increase the pixel resolution of the composite image compared to the pixel resolution of the camera and/or the photon detector array used to capture the recorded images. In some embodiments, the recorded images may be enhanced by the enhancement value n in a substantially similar manner as described in FIGS. 3C, 4C and 5C.

At block 804, an initial enhanced image of the article is retrieved. In some embodiments, the enhanced images may be retrieved from a memory of a computing device or a database. In some embodiments, the initial enhanced image of the article is retrieved as a base to combine subsequent enhanced images relative to the initial enhanced image. In some embodiments, the initial image is used as a base to form the composite image may be arbitrarily selected among the enhanced images. In some embodiments, the initial enhanced image may be selected to correspond to the initial image recorded of the article at an initial location. For example in FIG. 3C, the initial image 302″ corresponds to initial pixel image map of the article 302′ of FIG. 3B recorded when the article was at an initial location as illustrated as 302 of FIG. 3A. Similarly, in FIGS. 4C, the initial image 402″ corresponds to an initial pixel image map of the article 402′ illustrated in FIGS. 4B that was recorded while the article was at an initial location (e.g., 402 of FIG. 4A). In another example, the initial image 502″ corresponds to an initial pixel image map of the article 502′ illustrated in FIGS. 5B that was recorded of the article at an initial location, which is illustrated in 502 of FIG. 5A.

At block 806, a subsequent enhanced image of the article is retrieved. In some embodiments, the subsequent enhanced image is retrieved from a memory of a computing device and/or a database. In some embodiments, the subsequent enhanced image may be arbitrarily selected and retrieved among the n² enhanced images of the article. In some embodiments, the subsequent enhanced image may be selected and retrieved based on the order the image was recorded. For example, the subsequent enhanced image that is retrieved may correspond to the second recorded image of the article. In this example, the order of the recorded images may be determined based on a time stamp or a metadata associated with the images.

At block 808, the number of 1/n of a pixel the article was translated when the subsequent image was recorded relative to the initial location of the article in the initial image is determined. In some embodiments, the number of 1/n of a pixel that article was translated is determined by comparing the initial image and the subsequent images. In some embodiments, the determination may be based on metadata associated with the images indicating the number of 1/n of a pixel that the article was translated. In some embodiments, the determination may be made in a substantially similar manner as described in FIGS. 3C, 4C and 5C.

At block 810, a combined image of the initial image and the subsequent image is produced by offsetting the subsequent image relative to the initial image by the number of pixels corresponding to the number of 1/n pixels the article was translated as determined in block 808. In some embodiments, the images may be offset and combined in a substantially similar manner as described in FIGS. 3C, 4C and 5C.

At block 812, it is determined whether there are any remaining images to be combined. If it is determined that all n² images of the article have been combined, then method 800 proceeds to block 814. Otherwise, method 800 proceeds to block 816.

At block 816 (FIG. 8B), a subsequent enhanced image of the article is retrieved. In some embodiments, the subsequent enhanced image may be retrieved in a substantially similar manner as described in block 806. At block 818, the number of 1/n pixels that the article was translated when the subsequent image was recorded relative to the initial location of the article in the initial image is determined. In some embodiments, the determination in block 818 is implemented and performed in a substantially similar manner as described in block 808. At block 820, a combined image of the previously combined enhanced images and the subsequent enhanced image is produced by offsetting the subsequent enhanced image by a number of pixels corresponding to the number of 1/n of a pixel the article was translated as determined in block 816. In some embodiments, the subsequent enhanced image may be combined and offset in a substantially similar manner as described in block 810.

Once the subsequent enhanced image is combined with the previously combined images, method 800 returns to block 812 to determine whether any images remain to be combined. If there are any remaining images, then method 800 proceeds to block 816. Otherwise, method 800 proceeds to block 814.

At block 814 (FIG. 8A), a composite image of the article is produced. By combining the n², the composite image has a greater pixel resolution than the pixel resolution of a photon detector array used to capture the images of the article. In some embodiments, image interpolation may be used to combine images and produce a composite image with greater pixel resolution. In some embodiments, a means to produce a composite image, such as computer 160 of FIG. 1, may be used to produce the composite image.

As such, provided herein is an apparatus, comprising a light source for illuminating an article; a mount for mounting the article, wherein the mount is operable to longitudinally and/or latitudinally translate the article; a photon detecting array comprising a fixed pixel resolution; and a means for producing a composite image of the article, or a portion thereof, at a greater pixel resolution than the fixed pixel resolution of the photon detecting array by translating and imaging the article at sub-pixel distances.

In some embodiments, the apparatus further comprising a lens. In some embodiments, the lens is a telecentric lens. In some embodiments, the photon detecting array comprises a complementary metal-oxide semiconductor (“CMOS”), a scientific complementary metal-oxide semiconductor (“sCMOS”), or a charge-coupled device (“CCD”).

In some embodiments, the fixed pixel resolution of the photon detecting array is at least 5 megapixels. In some embodiments, the greater pixel resolution is at least two times greater than the fixed pixel resolution of the photon detecting array. In some embodiments, the greater pixel resolution is at least 100 times greater than the fixed pixel resolution of the photon detecting array.

In some embodiments, the means for producing a composite image of the article includes a computer configured to: record an initial image of the article at an initial location; iteratively cause the mount to translate the article a sub-pixel distance to a subsequent location and image the article in the subsequent location; and combine the images from each location to produce the composite image at the greater pixel resolution than the fixed pixel resolution of the photon detecting array. In some embodiments, the computer is further configured to: determine the sub-pixel distance to translate the mount to the subsequent location based on a pixel size of the photon detecting array, a magnification value of a lens of the apparatus, and the greater pixel resolution.

In some embodiments, images from each location are enhanced by a predetermined value. In some embodiments, the physical position of the photon detecting array and the light source are fixed, the article is a disk, and the computer is further configured to identify disk defects.

Also provided herein is an apparatus, comprising a photon detecting array configured to take images of an article; and a mount configured to support and translate the article by a sub-pixel distance, wherein the sub-pixel distance is based on a pixel size of the photon detecting array.

In some embodiments, the apparatus is configured to produce an image of the article that is of the pixel size of the photon detecting array and is at a greater pixel resolution than a pixel resolution of the photon detecting array.

In some embodiments, the apparatus further comprises a computer configured to: record an initial image of the article at an initial location; iteratively cause the mount to translate the article the sub-pixel distance to a subsequent location and record a subsequent image the article in the subsequent location; and combine the images from each location to produce a composite image at a greater pixel resolution than a pixel resolution of the photon detecting array. In some embodiments, the computer is further configured to determine the sub-pixel distance to translate the article. In some instances, the determining is based on the pixel size of the photon detecting array, on a magnification value of a lens of the apparatus, and an enhancement value n, wherein n is between 2 and 10,000, inclusive. In some embodiments, the computer is further configured to produce the composite image with a pixel resolution that is n times greater than the pixel resolution of the photon detecting array. In some embodiments, the photon detecting array remains in a fixed position while the article is translated in the direction by the sub-pixel distance.

Also provided herein is a method, comprising: receiving from a photon detecting array an initial image of an article at an initial location; translating the article a sub-pixel distance to a subsequent location and generating a subsequent image of the article at the subsequent location; and combining the initial image and the subsequent image to generate a composite image at a greater pixel resolution than a pixel resolution of the photon detecting array.

In some embodiments, generating the composite image comprises combining n2 number of images, and the composite image includes a pixel resolution that is n times greater than the pixel resolution of the photon detecting array. In some embodiments, translating the article the sub-pixel distance comprises translating the article 1/n of a pixel size of the photon detecting array. In some embodiments, n is between 2 and 10,000, inclusive. In some embodiments, the method further comprises determining the sub-pixel distance based on a pixel size of the photon detecting array, a magnification value of a lens, and an enhancement value n. In some instances, the greater pixel resolution is n times greater than the pixel resolution of the photon detecting array, and a camera includes the photon detecting array and the lens.

While the embodiments have been described and/or illustrated by means of particular examples, and while these embodiments and/or examples have been described in considerable detail, it is not the intention of the applicant(s) to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the embodiments, which scope is limited only by the following claims when appropriately construed.

What is claimed is:

1. An apparatus, comprising:
a light source for illuminating an article;
a photon detecting array comprising a fixed pixel resolution; and
a means for producing a composite image of the article, or a portion thereof, at a greater pixel resolution than the fixed pixel resolution of the photon detecting array by translating and imaging the article at sub-pixel distances.

2. The apparatus of claim 1 further comprising a lens, wherein the lens is a telecentric lens.

3. The apparatus of claim 1, wherein the photon detecting array comprises a complementary metal-oxide semiconductor (“CMOS”), a scientific complementary metal-oxide semiconductor (“sCMOS”), or a charge-coupled device (“CCD”).

4. The apparatus of claim 1, wherein the fixed pixel resolution of the photon detecting array is at least 5 megapixels.

5. The apparatus of claim 1, wherein the greater pixel resolution is at least two times greater than the fixed pixel resolution of the photon detecting array.

6. The apparatus of claim 1, wherein the greater pixel resolution is at least 100 times greater than the fixed pixel resolution of the photon detecting array.

7. The apparatus of claim 1 wherein the means for producing a composite image of the article includes a computer configured to:
record an initial image of the article at an initial location;
iteratively cause the mount to translate the article a sub-pixel distance to a subsequent location and image the article in the subsequent location; and
combine the images from each location to produce the composite image at the greater pixel resolution than the fixed pixel resolution of the photon detecting array.

8. The apparatus of claim 7, wherein the computer is further configured to:
determine the sub-pixel distance to translate the mount to the subsequent location based on a pixel size of the photon detecting array, a magnification value of a lens of the apparatus, and the greater pixel resolution.

9. The apparatus of claim 7, wherein images from each location are enhanced by a predetermined value.

10. The apparatus of claim 7, wherein
the physical position of the photon detecting array and the light source are fixed;
the article is a disk; and
the computer is further configured to identify disk defects.

11. An apparatus comprising:
a photon detecting array configured to take images of an article; and
a mount configured to support and translate the article by a sub-pixel distance, wherein the sub-pixel distance is based on a pixel size of the photon detecting array.

12. The apparatus of claim 11, wherein the apparatus is configured to produce an image of the article that is of the pixel size of the photon detecting array and is at a greater pixel resolution than a pixel resolution of the photon detecting array.

13. The apparatus of claim 11 further comprising a computer configured to:
record an initial image of the article at an initial location;
iteratively cause the mount to translate the article the sub-pixel distance to a subsequent location and record a subsequent image the article in the subsequent location; and
combine the images from each location to produce a composite image at a greater pixel resolution than a pixel resolution of the photon detecting array.

14. The apparatus of claim 13, wherein the computer is further configured to:
determine the sub-pixel distance to translate the article, wherein the determining is based
on the pixel size of the photon detecting array,
on a magnification value of a lens of the apparatus, and
an enhancement value n, wherein n is between 2 and 10,000, inclusive; and
produce the composite image with a pixel resolution that is n times greater than the pixel resolution of the photon detecting array.

15. The apparatus of claim 11, wherein the photon detecting array remains in a fixed position while the article is translated in the direction by the sub-pixel distance.

16. A method, comprising:
receiving from a photon detecting array an initial image of an article at an initial location;
translating the article a sub-pixel distance to a subsequent location and generating a subsequent image of the article at the subsequent location; and
combining the initial image and the subsequent image to generate a composite image at a greater pixel resolution than a pixel resolution of the photon detecting array.

17. The method of claim 16, wherein
generating the composite image comprises combining n² number of images, and
the composite image includes a pixel resolution that is n times greater than the pixel resolution of the photon detecting array.

18. The method of claim 17, wherein translating the article the sub-pixel distance comprises translating the article 1/n of a pixel size of the photon detecting array.

19. The method of claim 17, wherein n is between 2 and 10,000, inclusive.

20. The method of claim 16, further comprising:
determining the sub-pixel distance based on a pixel size of the photon detecting array, a magnification value of a lens, and an enhancement value n, wherein
the greater pixel resolution is n times greater than the pixel resolution of the photon detecting array, and
a camera includes the photon detecting array and the lens.
